(19) United States
(12) Patent Application Publication
(10) Pub. No.: US 2026/0077395 A1
(43) Pub. Date: Mar. 19, 2026

(54) Drain Cleaning Device

(71) Applicants: Stephen S. Turner, Edelstein, IL (US); Scott I. Turner, Chillicothe, IL (US)

(72) Inventors: Stephen S. Turner, Edelstein, IL (US); Scott I. Turner, Chillicothe, IL (US)

(21) Appl. No.: 19/399,103

(22) Filed: Nov. 24, 2025

Related U.S. Application Data
(63) Continuation-in-part of application No. 17/970,493, filed on Oct. 20, 2022, now Pat. No. 12,480,297.
(60) Provisional application No. 63/257,915, filed on Oct. 20, 2021.
(60) Provisional application No. 63/316,995, filed on Mar. 5, 2022.
(60) Provisional application No. 63/740,907, filed on Dec. 31, 2024.
(60) Provisional application No. 63/866,224, filed on Aug. 18, 2025.

(51) Int. Cl. B08B 9/045; B08B 9/043; E03C 1/302

(52) U.S. Cl. CPC B08B 9/045; B08B 9/0436; E03C 1/302

(57) ABSTRACT

A drain cleaning device for removing debris from a drain is disclosed herein. The drain cleaning device includes an elongated shaft section having a first end, a second end, and a shaft axis, the first end of the elongated shaft section being oppositely disposed relative to the second end of the elongated shaft section; and a tip section connected to the second end of the elongated shaft section, the tip section including a central core portion and a plurality of protruding elements extending from the central core portion, the plurality of protruding elements being disposed at least partially around a periphery of the central core portion. The first end of the elongated shaft section is configured to be coupled to a rotary motion input device that is sufficient to rotate the plurality of protruding elements of the tip section about the shaft axis.

### CROSS-REFERENCE TO RELATED APPLICATIONS

This patent application is a continuation-in-part of U.S. Nonprovisional patent application Ser. No. 17/970,493, entitled “Power Tool Adapter For A Drain Cleaning Device”, filed on Oct. 20, 2022, which claims priority to U.S. Provisional Patent Application No. 63/257,915, entitled “Power Tool Adapter For A Drain Cleaning Device”, filed on Oct. 20, 2021, and U.S. Provisional Patent Application No. 63/316,995, entitled “Pipe Cleaning Device”, filed on Mar. 5, 2022, all of the disclosures of which are herein expressly incorporated by reference in their entireties.

This patent application claims priority to U.S. Provisional Patent Application No. 63/740,907, entitled “Drain Cleaning Device”, filed on Dec. 31, 2024, and U.S. Provisional Patent Application No. 63/866,224, entitled “Drain Cleaning Device”, filed on Aug. 18, 2025, the disclosure of each of which is hereby incorporated by reference as if set forth in their entireties herein.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL SUBMITTED ON A COMPACT DISK

Not Applicable.

### BACKGROUND OF THE INVENTION

### 1. Field of the Invention

The invention generally relates to a drain cleaning device. More particularly, the invention relates to a drain cleaning device used for cleaning drains by removing hair and other debris that is collected in the upper portion of the drain where stopper or strainer mechanisms and other obstructions occur or collected anywhere along the drain pipe down to the bottom elbow bends of the drain where hair and other debris has collected (e.g., in the drain trap).

### 2. Background

Bathroom drains are clogged most often by hair that enters the drain and collects from the drain trap at the bottom up to the drain opening. Most frequently, the hair combines with sticky products such as soap, shampoo, and toothpaste and builds a “log-jam” of sorts where these drain obstructions catch the hair, and some settles in the drain trap. After sufficient amounts of hair have collected in the drain trap or around the upper opening, the water from the sink basin begins to drain noticeably more slowly, and eventually can completely block the water from draining. Drain chemicals, home remedies such as baking soda and vinegar and plungers are frequently used for these clogs, but often fail to dissolve or dislodge the hair clogging the drain. In extreme cases, the only remaining remedy is to disassemble the drain or use a device that can effectively reach, snag, and extract the hair (e.g., a drain snake).

Also, liquid or gel-based chemical drain unclogging agents can contain corrosive chemicals that may damage the drain structure. The drain cleaning chemicals may also cause health problems to those who handle the liquids or gels incorrectly. Another problem with chemical agents is that a significant portion of the chemical agent may flow past the hair-clog (for example, in the vertical portion of a bathroom sink drain) such that the chemical cannot effectively submerge the hair in order to completely dissolve it.

In addition, because the hair and other debris may be tightly twisted around the drain structure, it may be difficult to remove this hair and debris manually using a drain snake. The manual removal of this hair and other debris may be particularly difficult for a user that is elderly or disabled.

Therefore, what is needed is a drain cleaning device that enables a user to interchangeably utilize a power tool or a manual handle to clear sink and tub drain clogs.

### BRIEF SUMMARY OF EMBODIMENTS OF THE INVENTION

Accordingly, the present invention is directed to a drain cleaning device that substantially obviates one or more problems resulting from the limitations and deficiencies of the related art.

In accordance with one or more embodiments of the present invention, there is provided a drain cleaning device for removing debris from a drain. The drain cleaning device includes an elongated shaft having a first end, a second end, and a shaft axis, the first end of the elongated shaft being oppositely disposed relative to the second end of the elongated shaft, the elongated shaft further including a plurality of protruding elements projecting outwardly from the elongated shaft, the plurality of protruding elements being disposed at least partially around a periphery of the elongated shaft and along at least a portion of a length of the elongated shaft between the first end and the second end. In these one or more embodiments, the first end of the elongated shaft is configured to be coupled to a rotary motion input device that is sufficient to rotate the plurality of protruding elements of the elongated shaft about the shaft axis; and whereby, upon the elongated shaft being rotated by the rotary motion input device, the plurality of protruding elements are configured to grab and collect debris from a drain pipe.

In a further embodiment of the present invention, the rotary motion input device for rotating the elongated shaft is selected from the group consisting of: (i) a drill, (ii) a screwdriver, (iii) a power drill, (iv) a power screwdriver, and (v) a detachable handle section.

In yet a further embodiment, the elongated shaft further comprises a hook material strip bonded to the second end thereof, the hook material strip comprising the plurality of protruding elements of the elongated shaft, and the hook material strip being made from a hook side of a hook-and-loop fastener material.

In still a further embodiment, the elongated shaft is formed from a semi-flexible cable, the semi-flexible cable comprising a plurality of bundled wires, the hook material strip being bonded to an outer surface of the semi-flexible cable.

In yet a further embodiment, the elongated shaft comprises a plastic shaft.

In still a further embodiment, the drain cleaning device further comprises a power tool adapter configured to couple the first end of the elongated shaft section to the rotary motion input device, the power tool adapter includes an adapter body with a shank section for being inserted into a recess of the rotary motion input device.

In yet a further embodiment, the rotary motion input device is in a form of a detachable handle section configured to be detachably coupled to the elongated shaft of the drain cleaning device.

In still a further embodiment, the detachable handle section has a proximal end portion and a distal end portion, the distal end portion of the detachable handle section being configured to be detachably coupled to a proximal end portion of the elongated shaft of the drain cleaning device.

In yet a further embodiment, the drain cleaning device further comprises a sleeve member that is slidable along a length of the detachable handle section between (i) a disengaged position where the elongated shaft of the drain cleaning device is able to be released from the detachable handle section, and (ii) an engaged position where the distal end portion of the detachable handle section is locked into engagement with the proximal end portion of the elongated shaft of the drain cleaning device.

In still a further embodiment, in the engaged position of the sleeve member, the sleeve member is rotatably disposed about the detachable handle section, the sleeve member configured to be grasped by a hand of a user during the spinning of the drain cleaning device by the user so as to help stabilize the drain cleaning device, the drain cleaning device being configured to be rotated relative to the sleeve member while the sleeve member is held stationary by the hand of the user.

In yet a further embodiment, the detachable handle section comprises a pushbutton release assembly configured to releasably engage the proximal end portion of the elongated shaft of the drain cleaning device so as to releasably secure the detachable handle section to the elongated shaft.

In still a further embodiment, the elongated shaft further comprises a plurality of longitudinal sections that are configured to connect together using one or more extension couplers.

In yet a further embodiment, at least one of the one or more extension couplers comprises an extension coupler female portion that is configured to engage with a corresponding extension coupler male portion.

In still a further embodiment, the extension coupler female portion comprises a plurality of internal threads that are configured to threadingly engage with a corresponding plurality of external threads on the extension coupler male portion.

In yet a further embodiment, at least one of the plurality of longitudinal sections comprises a tip longitudinal section that includes the plurality of protruding elements, the tip longitudinal section configured to be discarded after being used to grab and collect the debris from the drain pipe.

In still a further embodiment, at least some of the plurality of longitudinal sections comprise a plurality of different tip longitudinal sections that are able to be interchangeably attached to a distal end portion of the elongated shaft.

In yet a further embodiment, the plurality of different tip longitudinal sections comprises one or more of the following: (i) a tip longitudinal section including a hook material strip, (ii) a tip longitudinal section including a brush with bristles, and (iii) a tip longitudinal section including a spiral spring-shaped tip.

In accordance with one or more other embodiments of the present invention, there is provided a drain cleaning device for removing debris from a drain. The drain cleaning device includes an elongated shaft section having a first end, a second end, and a shaft axis, the first end of the elongated shaft section being oppositely disposed relative to the second end of the elongated shaft section; and a tip section connected to the second end of the elongated shaft section, the tip section including a central core portion and a plurality of protruding elements extending from the central core portion, the plurality of protruding elements being disposed at least partially around a periphery of the central core portion. In these one or more embodiments, the first end of the elongated shaft section is configured to be coupled to a rotary motion input device that is sufficient to rotate the plurality of protruding elements of the tip section about the shaft axis; and whereby, upon the elongated shaft section being rotated by the rotary motion input device, the plurality of protruding elements are configured to grab and collect debris from a drain pipe.

It is to be understood that the foregoing general description and the following detailed description of the present invention are merely exemplary and explanatory in nature. As such, the foregoing general description and the following detailed description of the invention should not be construed to limit the scope of the appended claims in any sense.

### BRIEF DESCRIPTION OF THE SEVERAL VIEWS OF THE DRAWINGS

The invention will now be described, by way of example, with reference to the accompanying drawings, in which:

FIG. 1 is a perspective view of a drain cleaning assembly, according to an illustrative embodiment of the invention, wherein the drain cleaning assembly includes a power tool adapter and a first type of drain cleaning device;

FIG. 2 is a first side elevational view of the drain cleaning assembly of FIG. 1;

FIG. 3 is a second side elevational view of the drain cleaning assembly of FIG. 1;

FIG. 4 is a rear elevational view of the drain cleaning assembly of FIG. 1;

FIG. 5 is a front elevational view of the drain cleaning assembly of FIG. 1;

FIG. 6 is a first end view of the drain cleaning assembly of FIG. 1;

FIG. 7 is a second end view of the drain cleaning assembly of FIG. 1;

FIG. 8A is a side view illustrating the manner in which the power tool adapter is inserted into a drill;

FIG. 8B is another side view illustrating the manner in which the sleeve member of the power tool adapter is moved into a disengaged position;

FIG. 8C is yet another side view illustrating the manner in which the drain cleaning device is engaged with the power tool adapter;

FIG. 8D is still another side view illustrating the manner in which the sleeve member of the power tool adapter is moved into a engaged position so as to lock the drain cleaning device into engagement with the power tool adapter;

FIG. 9 is a perspective view illustrating the manner in which the drain cleaning assembly of FIG. 1 may be used to clean a drain pipe of a sink drain;

FIG. 10 is a longitudinal sectional view cut through the distal end portion of the power tool adapter and the proximal end portion of the drain cleaning device so as to illustrate the engagement between the power tool adapter and the drain cleaning device, wherein the section is generally cut along the cutting-plane line A-A in FIG. 5;

FIG. 11 is an exploded perspective view of the drain cleaning assembly of FIG. 1;

FIG. 12 is an enlarged perspective view of the distal end portion of the power tool adapter and the proximal end portion of the drain cleaning device (Detail “A” from FIG. 11), wherein the drain cleaning device is shown detached from the power tool adapter;

FIG. 13 is another enlarged perspective view of the distal end portion of the power tool adapter and the proximal end portion of the drain cleaning device, wherein the drain cleaning device is shown detached from the power tool adapter, similar to FIG. 12;

FIG. 14 is an enlarged exploded perspective view of the power tool adapter and the proximal end portion of the drain cleaning device;

FIG. 15 is a perspective view of a drain cleaning assembly, according to another illustrative embodiment of the invention, wherein the drain cleaning assembly includes a power tool adapter and a second type of drain cleaning device;

FIG. 16 is a front elevational view of the drain cleaning assembly of FIG. 15;

FIG. 17 is a rear elevational view of the drain cleaning assembly of FIG. 15;

FIG. 18 is an exploded partial perspective view of the drain cleaning assembly of FIG. 15, wherein a handle member that is interchangeable with the power tool adapter is further illustrated;

FIG. 19 is a longitudinal sectional view cut through an elongated rod section and elongated sleeve member of the drain cleaning device of FIG. 15, wherein the section is generally cut along the cutting-plane line B-B in FIG. 16;

FIG. 20A is a perspective view of a drain cleaning device, according to another illustrative embodiment of the invention, wherein the elongated shaft of the drain cleaning device is formed from a cable;

FIG. 20B is an enlarged broken perspective view of the drain cleaning device of FIG. 20A depicting details of the first and second ends of the drain cleaning device;

FIG. 21 is a front elevational view of the drain cleaning device of FIG. 20A;

FIG. 22 is a rear elevational view of the drain cleaning device of FIG. 20A;

FIG. 23 is a first side elevational view of the drain cleaning device of FIG. 20A;

FIG. 24 is a second side elevational view of the drain cleaning device of FIG. 20A;

FIG. 25 is a first end view of the drain cleaning device of FIG. 20A;

FIG. 26 is a second end view of the drain cleaning device of FIG. 20A;

FIG. 27 illustrates an exemplary wire configuration for the elongated shaft of the drain cleaning device of FIG. 20A, wherein the section is generally cut along the cutting-plane line C-C in FIG. 20B;

FIG. 28 is an enlarged perspective view of the distal end portion of the drain cleaning device (Detail “B” from FIG. 20B);

FIG. 29 is a perspective view illustrating the manner in which the drain cleaning device of FIG. 20A may be used to clean a drain pipe of a sink drain;

FIG. 30A is a perspective view of a drain cleaning device, according to still another illustrative embodiment of the invention, wherein the drain cleaning device has a plastic elongated shaft and the drain cleaning device is provided with a detachable handle section;

FIG. 30B is an enlarged broken perspective view of the drain cleaning device of FIG. 30A depicting details of the detachable handle section and the first and second ends of the elongated shaft of the drain cleaning device;

FIG. 31 is a bottom plan view of the detachable handle section of the drain cleaning device of FIG. 30A;

FIG. 32 is a top plan view of the detachable handle section of the drain cleaning device of FIG. 30A;

FIG. 33 is a side elevational view of the detachable handle section of the drain cleaning device of FIG. 30A;

FIG. 34 is an exploded partial perspective view of the drain cleaning device of FIG. 30A;

FIG. 35 is an enlarged partial perspective view of the drain cleaning device of FIG. 30A depicting the insertion of the elongated shaft into the detachable handle section, wherein the sleeve is in the disengaged position;

FIG. 36 is another enlarged partial perspective view of the drain cleaning device of FIG. 30A depicting the sleeve of the detachable handle section in the engaged position securing the elongated shaft into the detachable handle section;

FIG. 37 is a longitudinal sectional view cut through the distal end portion of the detachable handle section and the proximal end portion of the drain cleaning device so as to illustrate the engagement between the detachable handle section and the drain cleaning device, wherein the section is generally cut along the cutting-plane line D-D in FIG. 36;

FIG. 38 is a perspective view illustrating the manner in which the drain cleaning device of FIG. 30A may be used to clean a drain pipe of a sink drain;

FIG. 39 is an enlarged broken perspective view of a drain cleaning device, according to yet another illustrative embodiment of the invention, wherein the elongated shaft is provided with an extended hook material strip at the end thereof;

FIG. 40 is a longitudinal sectional view cut through the distal end portion of the elongated shaft so as to illustrate the extended hook material strip at the end thereof, wherein the section is generally cut along the cutting-plane line E-E in FIG. 39;

FIG. 41 is an overall perspective view of a drain cleaning device, according to still another illustrative embodiment of the invention, wherein the drain cleaning device is provided with an elongated shaft that is extendable;

FIG. 42 is a first enlarged partial perspective view of the drain cleaning device of FIG. 41;

FIG. 43 is a second enlarged partial perspective view of the drain cleaning device of FIG. 41;

FIG. 44 is an overall perspective view of a drain cleaning device, according to yet another illustrative embodiment of the invention, wherein various types of tips that can be used with the drain cleaning device are depicted;

FIG. 45 is an enlarged broken perspective view of the drain cleaning device of FIG. 44 depicting details of the connection fitting and the various types of tips that can be used with the drain cleaning device;

FIG. 46 is a side elevational view of the drain cleaning device of FIG. 44, wherein the drain cleaning device is provided with the first type of tip thereon;

FIG. 47 is a longitudinal sectional view cut through the distal end portion of the detachable handle section and the proximal end portion of the drain cleaning device, wherein the drain cleaning device is in an engaged position with the detachable handle section, and the section is generally cut along the cutting-plane line G-G in FIG. 46;

FIG. 48 is a longitudinal sectional view cut through the distal end portion of the detachable handle section and the proximal end portion of the drain cleaning device, wherein the drain cleaning device is in a disengaged position with the detachable handle section, and the section is generally cut along the cutting-plane line G-G in FIG. 46;

FIG. 49 is a longitudinal sectional view cut through the connection fitting that connects the removable tip section to the elongated rod section, wherein the section is generally cut along the cutting-plane line H-H in FIG. 46;

FIG. 50 is an enlarged perspective end view of a distal end portion of the detachable handle section of the drain cleaning device of FIG. 44, wherein details of the pushbutton release at the distal end of the detachable handle section are shown;

FIG. 51 is a longitudinal sectional view cut through the distal end portion of the detachable handle section, wherein the pushbutton on the handle section has not yet been depressed and the drain cleaning device is in a disengaged position, and wherein the section is generally cut along the cutting-plane line F-F in FIG. 45;

FIG. 52 is a longitudinal sectional view similar to that depicted in FIG. 51, except that the pushbutton of the handle section has been depressed and the drain cleaning device is about to be inserted into the handle section;

FIG. 53 is a longitudinal sectional view similar to that depicted in FIG. 51, except that the drain cleaning device has now been inserted into the handle section, and the adapter of the drain cleaning device has been locked in place by the pushbutton of the handle section;

FIG. 54 is an enlarged broken perspective view of a drain cleaning device, according to still another illustrative embodiment of the invention, wherein the drain cleaning device is provided with a different type of connection fitting and various types of tips that can be used with the drain cleaning device are depicted;

FIG. 55A is a longitudinal sectional view cut through the connection fitting that connects the removable tip section to the elongated rod section, wherein the removable tip section has not yet been inserted into the connection fitting, and the section is generally cut along the cutting-plane line I-I in FIG. 54; and

FIG. 55B is a longitudinal sectional view similar to that depicted in FIG. 55A, except that the cylindrical end tip of the removable tip section has now been inserted into the connection fitting, and the removable tip section of the drain cleaning device has been locked in place by the connection fitting.

Throughout the figures, the same parts are always denoted using the same reference characters so that, as a general rule, they will only be described once.

### DETAILED DESCRIPTION OF EMBODIMENTS OF THE INVENTION

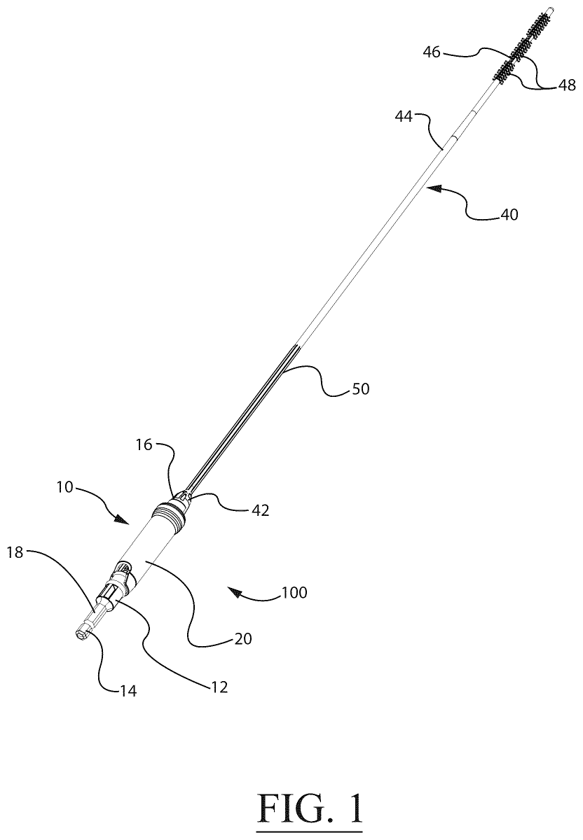

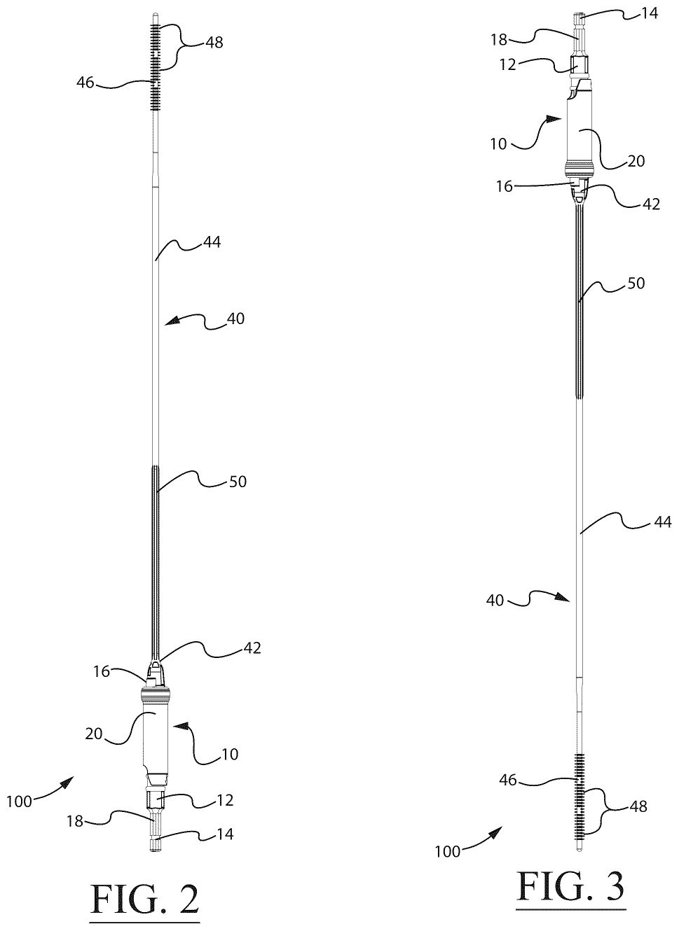

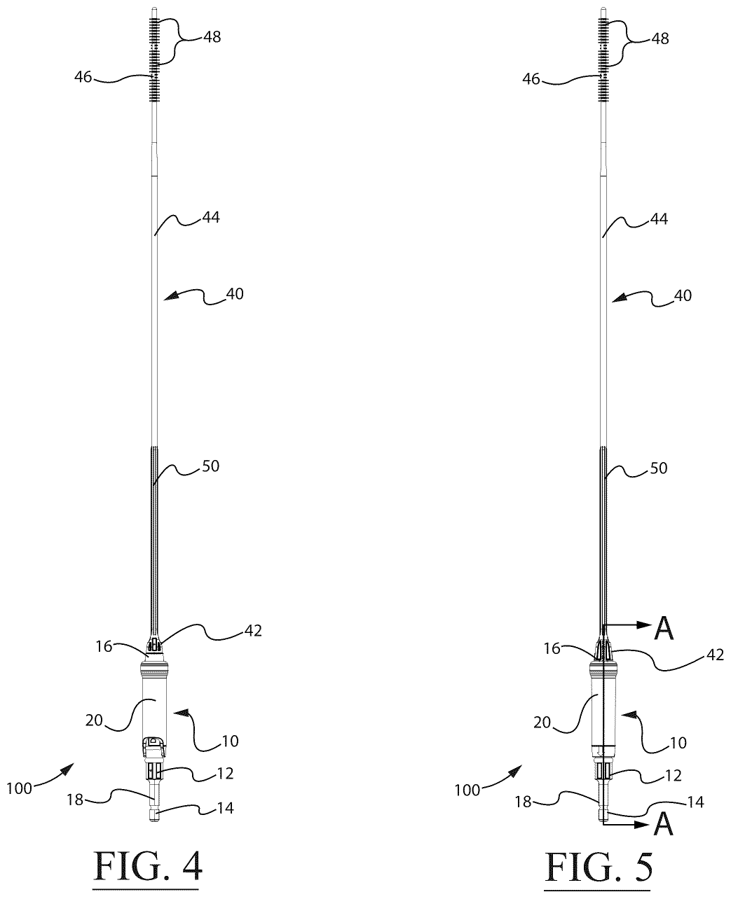

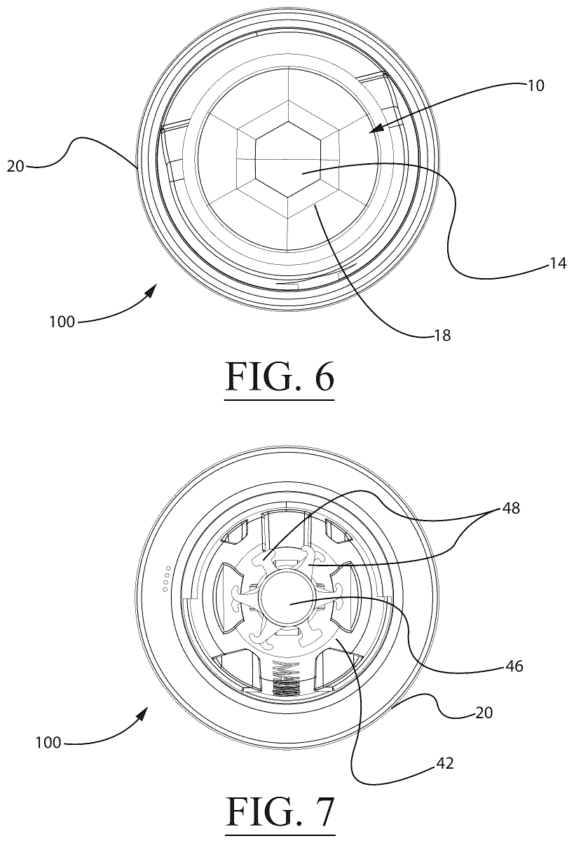

A first illustrative embodiment of a drain cleaning assembly is seen generally at 100 in FIGS. 1-7. FIG. 1 shows a perspective view of the illustrative drain cleaning assembly 100 including a reusable power tool adapter 10 and a disposable drain cleaning device 40. The disposable drain cleaning device 40 is attached to the power tool adapter 10 by engagement of the proximal end portion 42 (i.e., the end that is closest to the person when operating the device) of the drain cleaning device 40 fully engaged with the distal end portion 16 of the power tool adapter 10. A slidable sleeve member 20 is shown in the engaged position and the drain cleaning device 40, as shown in FIG. 1, is in the fully engaged configuration. The sleeve member 20 in this engaged position ensures that the drain cleaning device 40 and power tool adapter 10 are fully engaged, i.e., interlocked at their corresponding ends, and the device is ready for use, such as for clearing a clogged drain pipe or for other similar pipe-cleaning functions.

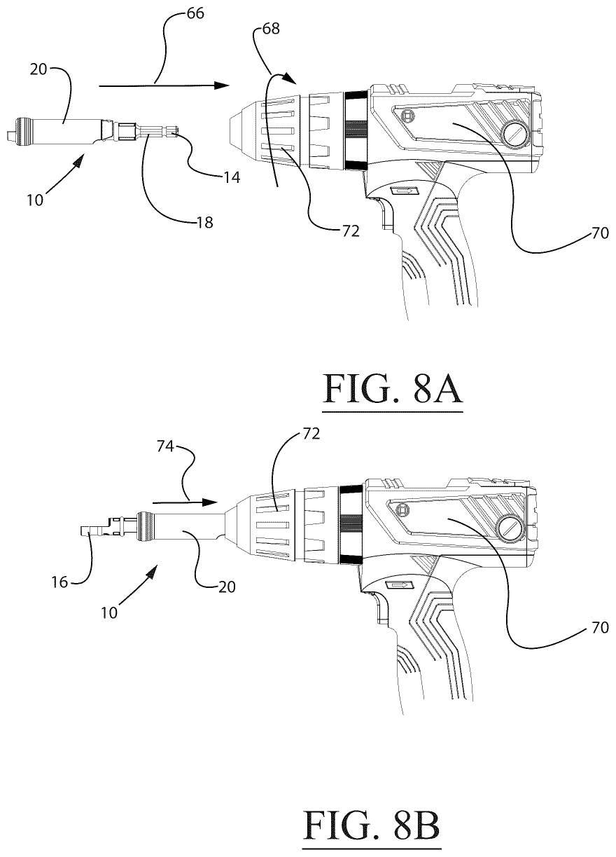

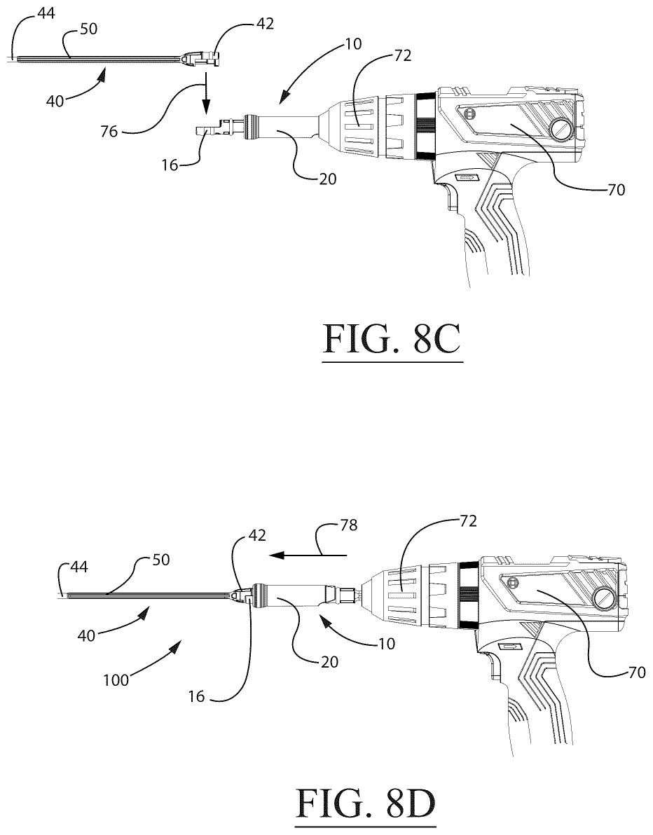

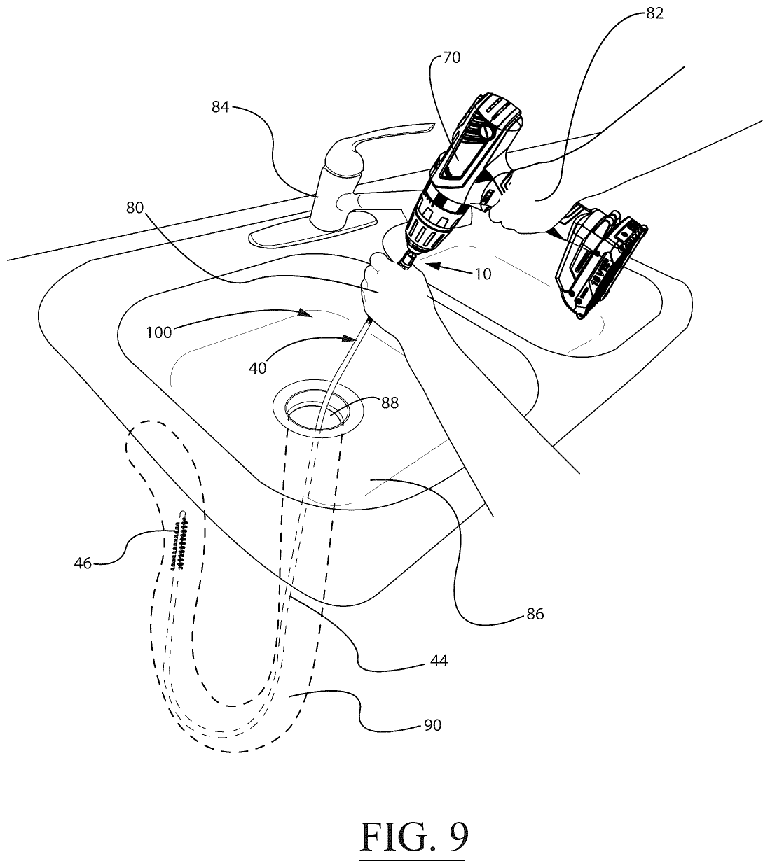

In the illustrative embodiment, as shown in FIGS. 1-5 and 11, the power tool adapter 10 generally comprises an adapter body 12 having a proximal end portion 14 and a distal end portion 16, the proximal end portion 14 of the adapter body 12 being oppositely disposed relative to the distal end portion 16 of the adapter body 12. In FIGS. 1-5, it can be seen that the distal end portion 16 of the adapter body 12 is configured to be coupled to a drain cleaning device 40 having a plurality of hook elements 48 disposed thereon, the plurality of hook elements 48 configured to grab and collect debris from a drain pipe. Also, as shown in FIGS. 1-5, the proximal end portion 14 of the adapter body 12 is configured to be coupled to a rotary motion input device (e.g., a drill 70—see FIGS. 8A-8D) that is sufficient to rotate the plurality of hook elements 48 of the drain cleaning device 40 about a rotational axis so as to grab and collect the debris from a drain pipe 88 (refer to FIG. 9).

In the illustrative embodiment, as shown in FIGS. 1-5 and 8A, it can be seen that the proximal end portion 14 of the adapter body 12 of the power tool adapter 10 comprises a shank section 18 for being inserted into a recess of the rotary motion input device (e.g., a drill 70). For example, the rotary motion input device for rotating the drain cleaning device 40 may comprise a drill, a screwdriver, a power drill, or a power screwdriver. In the illustrative embodiment, the power tool adapter 10 is configured for use with a drill 70, and the shank section at the proximal end portion of the adapter body is in a form of a drill bit shank section 18 for being inserted into a drill chuck recess. In the illustrative embodiment of FIGS. 1-5 and 8A, the drill bit shank section 18 has a generally hexagonal cross-sectional shape for being inserted into the drill chuck recess. In another embodiment, the drill bit shank section may have a generally circular cross-sectional shape for being inserted into the drill chuck recess.

In the illustrative embodiment, as will be described in further detail hereinafter, a user inserts the drill bit shank section 18 into a drill and tightens the chuck in the same fashion as using a drill bit. The slidable sleeve member 20 moves axially along the center of the power tool adapter 10 between an engaged position (i.e., a locking position) and a disengaged position (i.e., a release position). This sliding action of the sleeve member 20 fully engages or releases the replaceable drain cleaning device 40, which attaches to the distal end portion 16 of the adapter body 12. Once the drill bit shank section 18 of the power tool adapter 10 is locked into the drill chuck, the user grasps the drill in one hand and the spinning sleeve member 20 with the other hand, and inserts the attached drain cleaning device 40 into a sink or tub drain until they engage the resistance of a clog. Then, rather than having to manually crank the device 40, the user simply runs the drill on slow speed and allows the drill to power the drain cleaning device 40, rather than using the effort of manually cranking the device 40. The user can then detach the removable drain cleaning device 40 by sliding the spinning sleeve 20 of the power tool adapter 10 up toward the proximal drill end, exposing the mated, interlocking ends of both the adapter 10 and removable drain cleaning device 40, thereby allowing for removal and replacement of the drain cleaning device 40.

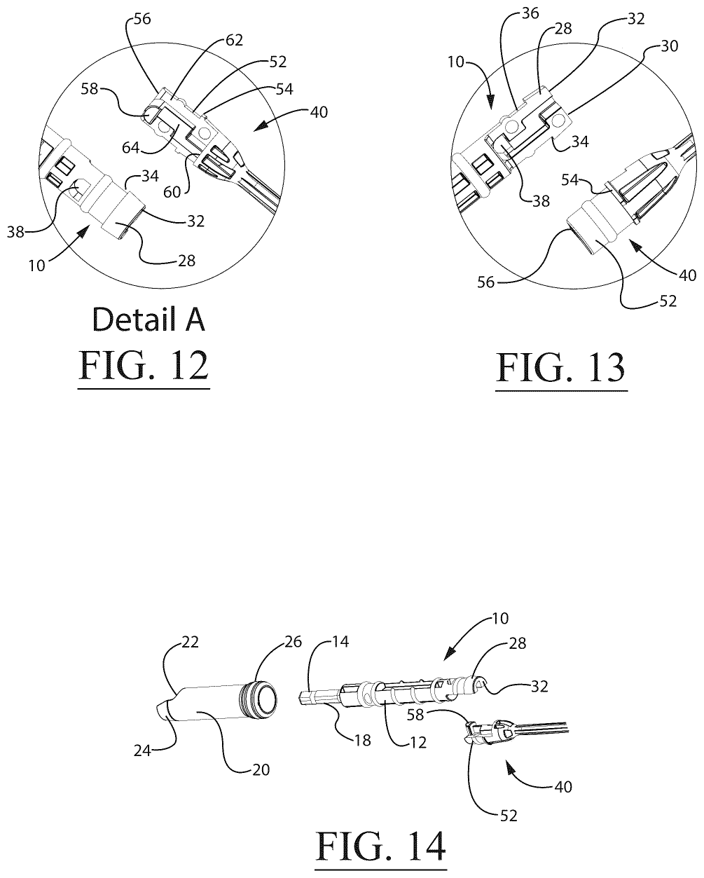

In the illustrative embodiment, the sleeve member 20 of the power tool adapter 10 can be moved back and forth between two possible positions along the adapter body 12: (i) a disengaged position (see FIGS. 12 and 13) where the drain cleaning device 40 is able to be released from the power tool adapter 10, and (ii) an engaged position (see FIGS. 1-5) where the distal end portion 16 of the adapter body 12 is locked into engagement with the proximal end portion 42 of the drain cleaning device 40.

As shown in FIGS. 1-5 and 7, the distal tip section 46 of the drain cleaning device 40 can be equipped with a hair-catching structure (e.g., a plurality of hook elements 48) that collects hair material or debris clogging a drain.

After use, the drain cleaning device 40 is disengaged from the power tool adapter 10 (as described below) and can be discarded in an appropriate disposal receptacle, or in an appropriate recycling collection container.

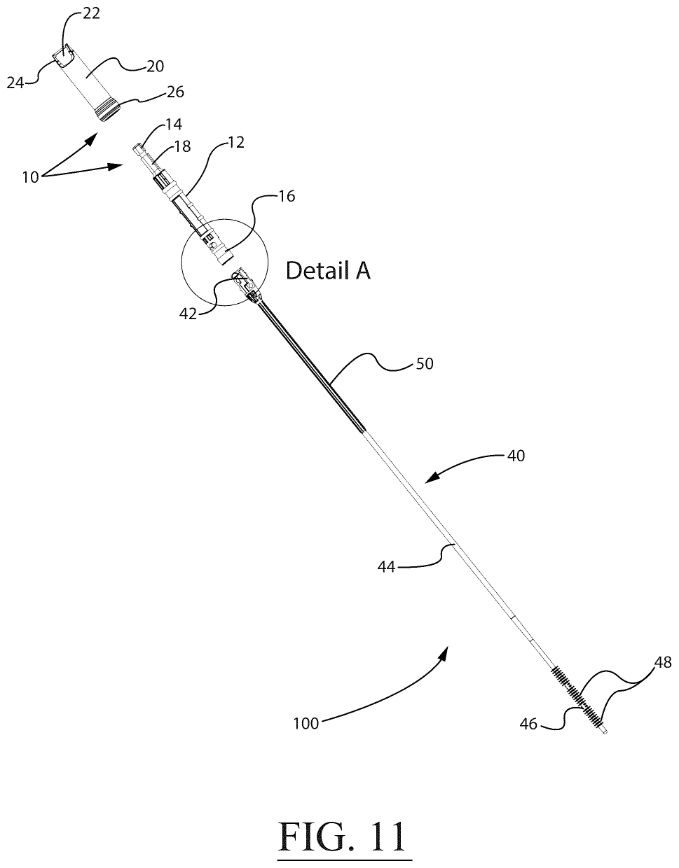

In the illustrative embodiment, the sleeve member 20 of the power tool adapter 10 has a generally cylindrical shape, but may include a notch 22 at its proximal end 24 (see FIGS. 11 and 14). When the sleeve member 20 is moved backward to its disengaged position (i.e., the FIG. 8B position), the interlocking ends of the drain cleaning device 40 and power tool adapter 10 are exposed and can be detached.

In the illustrative embodiment, the interlocking region at the proximal end of the drain cleaning device 40 includes a partial annular shoulder stop 54 and a partial cylindrical end section 52 that match a respective partial annular shoulder stop 34 and partial cylindrical end section 28 at the distal end of the power tool adapter 10 (see FIGS. 12 and 13). When the sleeve member 20 is moved to the disengaged position as shown in FIG. 8B, the two corresponding partial cylindrical portions 28 and 52, are exposed and can be decoupled or detached. Alternatively, when the sleeve member 20 is moved to the engaged position (see FIGS. 1-5 and 8D), the distal end 26 of the sleeve member 20 is moved axially forward until it rests against the two partial annular shoulder stops, 34 and 54. When a drain cleaning device 40 is engaged, i.e., its proximal end portion 42 is interlocked with the distal end portion 16 of the power tool adapter body 12, the sleeve member 20 can be moved to its engaged position and the drain cleaning device 40 is ready for use and can be properly operated.

The interlocking region of the drain cleaning device 40 and the power tool adapter 10 is shown in more detail in the illustrative embodiment of FIGS. 12 and 13.

When the sleeve member 20 is moved to its disengaged position, the drain cleaning device 40 can be disengaged from the distal end portion 16 of the power tool adapter 10. In this position, the partial cylindrical end section 28 at the distal end of the power tool adapter 10 is clearly exposed (see FIG. 8B).

When interlocked with the corresponding end of the drain cleaning device 40, the partial cylindrical end section 52 of the drain cleaning device 40 combines with the partial cylindrical end section 28 at the distal end of the power tool adapter 10 to form a generally cylindrical interlocked structure that fits inside the bore of the sleeve member 20; and this interlocked structure can rotate inside the sleeve member 20 (e.g., during routine operation) when the sleeve is moved to the engaged position.

In addition, in the illustrative embodiment shown in FIGS. 1-5, when the drain cleaning device 40 is interlocked with the power tool adapter 10, protrusion 58 (see FIG. 12) of the drain cleaning device 40 fits in the corresponding opening 38 (see FIGS. 12 and 13), and axial stop 60 and surfaces 62 and 64 of the proximal end of the drain cleaning device 40 fit in the corresponding stop 32 and surfaces 30 and 36 at the distal end of power tool adapter 10 (refer to FIGS. 12-14).

In the illustrative embodiment, a further shaped axial stop surface 56 is provided at the proximal end of the drain cleaning device 40 (see FIGS. 12 and 13), which matches a correspondingly shaped cavity or opening (in axially proximal surface of opening 38) in the distal end of the power tool adapter 10 to ensure a uniquely matched interlock between the drain cleaning device 40 and the power tool adapter 10. That is, as best shown in FIGS. 12 and 13, the partial cylindrical end section 52 of the drain cleaning device 40 is provided with an internal zigzag protruding surface 64 that interlocks with an internal zigzag recess in the partial cylindrical end section 28 of the power tool adapter 10 connected to opening 38.

In the illustrative embodiment, a further detent can be provided at the distally lower surface of protrusion 58 to engage with a corresponding receiving indentation in the radially outer portion of opening 38 in the power tool adapter 10, in order to ensure a snap fit or other secure attachment.

In the illustrative embodiment, contact surface 62 at the distal end of the drain cleaning device 40 mates with corresponding contact surface 36 at the distal end of power tool adapter 10, when the drain cleaning device 40 and power tool adapter 10 are fully engaged. Similarly, when engaged, axial stop surface 60 at the end of the drain cleaning device 40 mates with the corresponding adapter stop surface 32. Furthermore, any tab feature, as shown projecting from surface 36 of the distal end of the power tool adapter 10, can be provided to mate with a corresponding opening in the proximal end of the drain cleaning device 40.

However, it is noted that the combination of the protrusion 58 and corresponding opening 38, as well as other notch-opening relationships between the proximal end of the drain cleaning device 40 and the distal end of the power tool adapter 10 are exemplary of mating relationships that can vary in size and shape. It is most important that the mating contours of the proximal end of the drain cleaning device 40 and the corresponding distal end of the power tool adapter 10 match in a manner that ensures the adequate transmission of the torque produced by the power tool (e.g., the drill 70 in FIG. 9) to the distal tip section 46 of the drain cleaning device 40 without loosening or disengaging the two interlocked ends during use. It is also important that different reusable power tool adapters 10 be provided with unique mating contours at the interlocking end section to match drain cleaning devices 40 that are uniquely matched to mate and interlock with the reusable power tool adapter 10.

The particular contour of the matching shaped protrusion of the drain cleaning device 40 and shaped opening of the power tool adapter 10, ensure that a unique drain cleaning device 40 can be uniquely engaged with a correspondingly unique power tool adapter 10.

A kit containing a set of differently shaped drain cleaning devices, each with a correspondingly matched power tool adapter 10, can be used, so long as the interlocking ends are suitably matched and the rotation of the power tool adapter 10 can cause the rotation of the drain cleaning device to remove debris from piping structures. Different kits can contain drain cleaning devices that are matched to one unique power tool adapter 10, or to more than one power tool adapter in different kits. The drain cleaning devices in any individual kit have interlocking portions with proximal contours that match the corresponding contours of the interlocking portions of the power tool adapters in the individual kits.

In the illustrative embodiment, with reference to FIGS. 1-5, it can be seen that the drain cleaning device 40 generally comprises an elongated rod section 44 with a plurality of longitudinally extending ribs 50 disposed along a length thereof, the plurality of longitudinally extending ribs 50 configured to add structural rigidity to the elongated rod section 44, and the plurality of longitudinally extending ribs 50 further configured to facilitate the cleaning of grime from a side of a drain pipe 90 (see FIG. 9); and a tip section 46 connected to the elongated rod section 44, the tip section 46 including a plurality of hook elements 48 disposed thereon (see FIGS. 1-5), the plurality of hook elements 48 configured to grab and collect debris from the drain pipe 90.

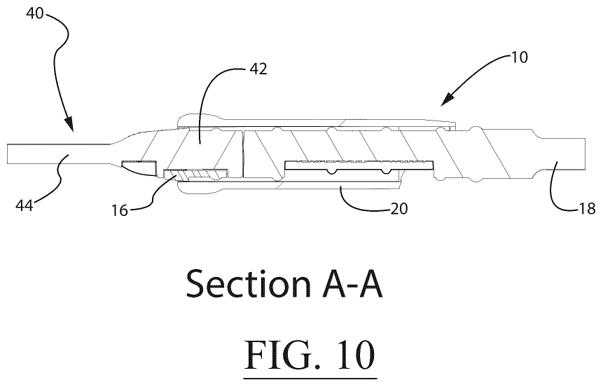

In the illustrative embodiment, the plurality of hook elements 48 of the tip section 46 are in the form of a plurality of injection-molded micro-hook elements configured to grab and collect the hair and/or debris from the drain pipe being cleaned. In the illustrative embodiment, the plurality of injection-molded micro-hook elements may be in the form of inverted J-shaped projections and T-shaped projections protruding outwardly from the elongated body of the cleaning device 40. The plurality of injection-molded micro-hook elements may be disposed on opposite first and second sides of the elongated body of the cleaning device 40. The injection-molded micro-hook inverted J-shaped elements that are disposed on the first side and the second side of the elongated body of the cleaning device may be arranged in rows where every other injection-molded micro-hook element points in an opposite direction (i.e., the injection-molded micro-hook elements point in alternating directions along the length of the elongated body-see e.g., FIGS. 10-12 in U.S. Pat. No. 10,857,577, the entire disclosure of which is incorporated herein by reference).

In other embodiments, the plurality of hook elements of the drain cleaning device 40 may comprise a hook material strip 30 (e.g., made from the hook portion of Velcro®—see e.g., FIGS. 5 and 9 of U.S. Pat. No. 10,857,577), rather than being injection-molded micro-hook elements.

In the illustrative embodiment, the drain cleaning devices 40 are preferably disposable and can be made of any suitable disposable, recyclable or biodegradable material (e.g., a suitable plastic), such as polyethylene, polystyrene, polycarbonate, acrylic polymer, or nylon. The power tool adapter 10 is preferably reusable and can be made of a suitably durable material (e.g., a suitable plastic) to withstand repeated engagement and disengagement with drain cleaning devices 40 and repeated use.

Now, with reference to the illustrative embodiment of FIGS. 8A-8D, the manner in which the drain cleaning assembly 100 is attached to a driving power tool (e.g., a drill 70) will be explained. First of all, as shown in FIG. 8A, the drill bit shank section 18 of the power tool adapter 10 is inserted into the chuck 72 of the battery-powered drill 70 by a user (as diagrammatically indicated by the horizontal arrow 66), and then the user tightens the jaws of the drill chuck 72 onto the drill bit shank section 18 of the power tool adapter 10 using the tightening collar of the chuck 72 (as diagrammatically indicated by the curved arrow 68). Secondly, as shown in FIG. 8B, the user slides the sleeve member 20 into its disengaged position (as diagrammatically indicated by the horizontal arrow 74). Then, turning to FIG. 8C, the user engages the proximal end portion 42 of the drain cleaning device 40 with the distal end portion 16 of the power tool adapter 10 (as diagrammatically indicated by the vertical arrow 76). Finally, once the proximal end portion 42 of the drain cleaning device 40 is engaged with the distal end portion 16 of the power tool adapter 10, the user slides the sleeve member 20 into its engaged position (as diagrammatically indicated by the horizontal arrow 78 in FIG. 8D) so as to secure the drain cleaning device 40 to the power tool adapter 10.

When the drain cleaning assembly 100 is in the fully engaged configuration as shown in FIG. 8D, the drain cleaning assembly 100 is ready for use. The distal tip section 46 of the drain cleaning device 40 can be inserted into a clogged drain or other similarly obstructed pipe. The user then places one hand 80 on the sleeve member 20 of the power tool adapter 10 and uses the other hand 82 to hold the drill 70. Pressing the trigger on the drill 70 causes the drain cleaning device 40 to rotate inside the clogged drain or obstructed pipe, thereby removing obstructing materials. The power tool adapter 10 can be turned indefinitely to rotate the drain cleaning device 40, thereby continuously collecting debris at the distal end of the drain cleaning device 40.

In FIG. 9, the operation of the drain cleaning assembly 100 is illustrated. More specifically, FIG. 9 shows the inventive drain cleaning assembly 100 being used in a sink 86 to remove clogging debris from the drain pipe 90 of the sink 86. The sink 86 has an associated faucet 84 for dispensing water into the sink 86. In the illustrative embodiment, the diameter of the elongated rod section 44 of the device 40 is sufficiently narrow to be easily inserted through openings in a typical drain cover all the way to the drain trap, often found in older residential bathrooms or modern drains having pop-up stoppers. Referring again to FIG. 9, after insertion of the elongated rod section 44 into the drain 88, the drain cleaning device 40 is rotated by the drill 70, thus winding into and capturing the clogging debris. The particular construction of the hook elements on the tip section 46 allows the debris to be collected and grabbed by the drain cleaning device 40. After grabbing the clogging debris, the device 40 is removed from the drain 88.

In one or more embodiments, the drain cleaning device 40 is configured to be discarded after being used to remove the debris from the drain pipe 90. In other words, the drain cleaning device 40 is disposable, and is designed for single cleaning of a drain. The used drain cleaning device 40 with the collected debris can be safely and environmentally discarded. Then, a new drain cleaning device 40 can be attached to the power tool adapter 10, and used to remove hair from another clogged drain.

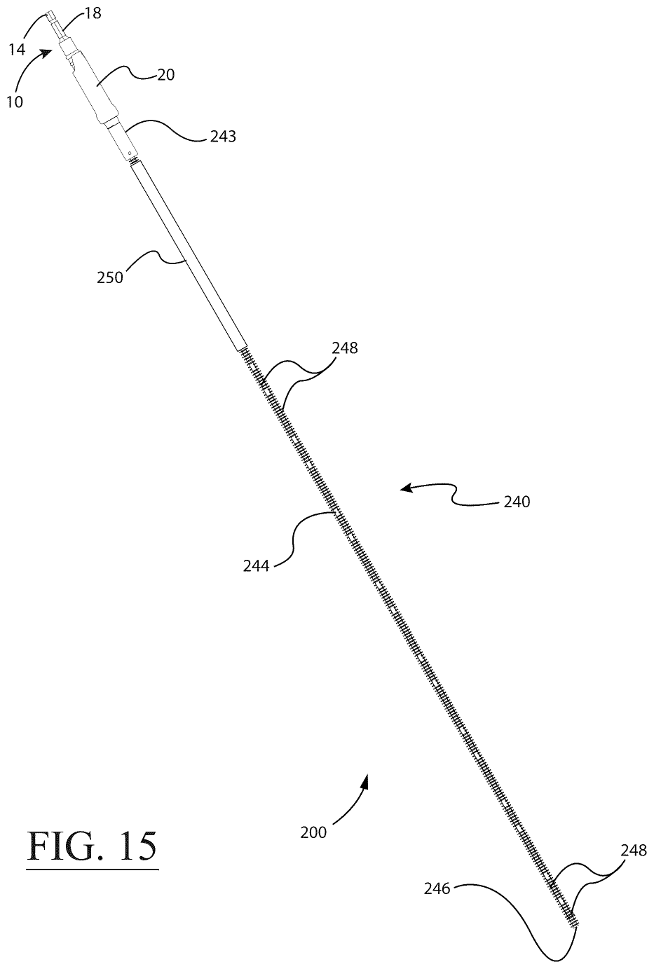

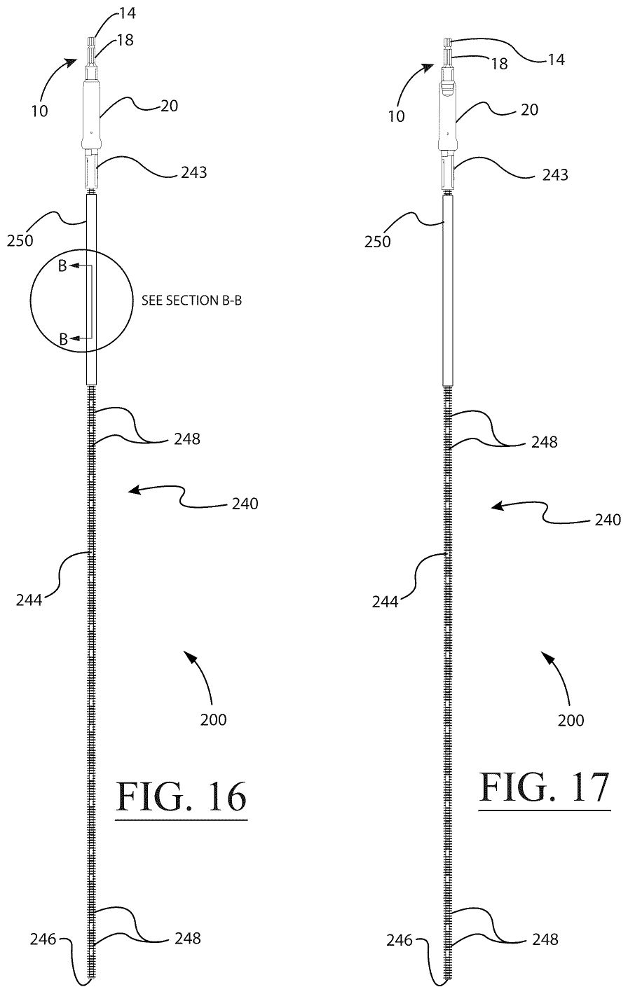

A second illustrative embodiment of a drain cleaning assembly is seen generally at 200 in FIGS. 15-17. FIG. 15 shows a perspective view of the illustrative drain cleaning assembly 200 including the reusable power tool adapter 10 and a disposable drain cleaning device 240. Referring to these figures, it can be seen that, in many respects, the illustrative embodiment of FIGS. 15-17 is similar to that of the illustrative embodiment of FIGS. 1-7. Moreover, many elements are common to both such embodiments. For the sake of brevity, the elements that the illustrative embodiment of FIGS. 15-17 has in common with the embodiment of FIGS. 1-7 will not be discussed in detail because these components have already been described above.

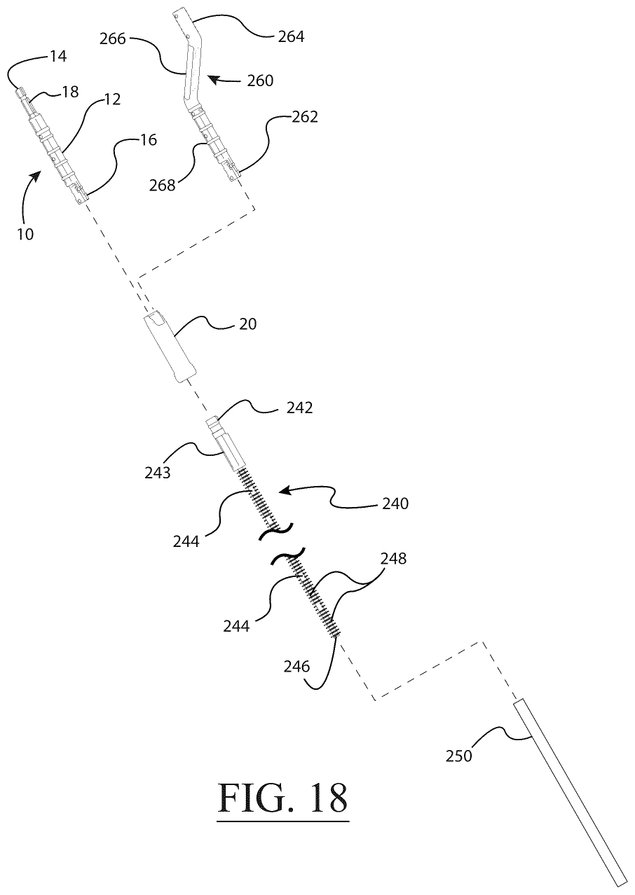

Similar to that described above for the first illustrative embodiment, the disposable drain cleaning device 240 of the second illustrative embodiment is attached to the power tool adapter 10 by engagement of the proximal end portion 242 (i.e., the end that is closest to the person when operating the device) of the drain cleaning device 240 fully engaging with the distal end portion 16 of the power tool adapter 10 (see FIG. 18). A slidable sleeve member 20 is shown in the engaged position and the drain cleaning device 240, as shown in FIG. 15, is in the fully engaged configuration. The sleeve member 20 in this engaged position ensures that the drain cleaning device 240 and power tool adapter 10 are fully engaged, i.e., interlocked at their corresponding ends, and the device is ready for use, such as for clearing a clogged drain pipe or for other similar pipe-cleaning functions.

In the second illustrative embodiment, with reference to FIGS. 15-17, it can be seen that the drain cleaning device 240 generally comprises an elongated rod section 244 or elongated shaft section 244 having a first end with connector section 243 and a second end with a tip section extending to a tip 246. The first end of the elongated rod section 244 is oppositely disposed relative to the second end of the elongated rod section 244. The elongated rod section 244 further includes the plurality of hook elements 248 projecting outwardly from the elongated rod section 244. In the illustrative embodiment, the plurality of hook elements 248 are disposed around a periphery of the elongated rod section 244 and along a length of the elongated rod section 244 between the first end and the second ends (see FIG. 15).

In the illustrative embodiment, the plurality of hook elements 248 on the elongated rod section 244 are in the form of a plurality of injection-molded micro-hook elements configured to grab and collect the hair and/or debris from the drain pipe being cleaned. In the illustrative embodiment, the plurality of injection-molded micro-hook elements may be in the form of inverted J-shaped projections and T-shaped projections protruding outwardly from the elongated body of the cleaning device 240. The plurality of injection-molded micro-hook elements may be disposed on opposite first and second sides of the elongated body of the cleaning device 240. The injection-molded micro-hook inverted J-shaped elements that are disposed on the first side and the second side of the elongated body of the cleaning device may be arranged in rows where every other injection-molded micro-hook element points in an opposite direction (i.e., the injection-molded micro-hook elements point in alternating directions along the length of the elongated body-see e.g., FIGS. 10-12 in U.S. Pat. No. 10,857,577, the entire disclosure of which is incorporated herein by reference).

In other embodiments, the elongated rod section further comprises a central core portion and an outer covering bonded to the central core portion. The outer covering is formed from a hook material strip, and the hook material strip comprises the plurality of hook elements of the elongated rod section. In these other embodiments, the hook material strip may be made from a hook side of a hook-and-loop fastener material (e.g., made from the hook portion of Velcro®—see e.g., FIGS. 5 and 9 of U.S. Pat. No. 10,857,577), rather than being injection-molded micro-hook elements.

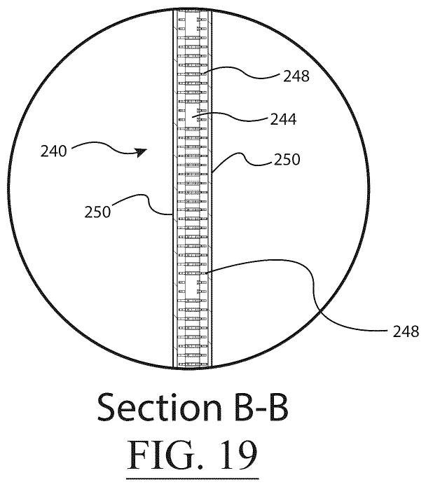

Referring to FIGS. 15, 18, and 19, in the second illustrative embodiment, the drain cleaning device 240 further comprises an elongated sleeve member 250 rotatably disposed on a longitudinal portion of the elongated rod section 244. The elongated sleeve member 250 is configured to be grasped by a hand of a user during the spinning of the drain cleaning device 240 by the rotary motion input device (e.g., a drill 70) so as to help stabilize the drain cleaning device 240. The drain cleaning device is configured to be rotated relative to the elongated sleeve member 250 while the elongated sleeve member 250 is held stationary by the hand of the user (e.g., similar to the adapter sleeve member 20 described above). In the illustrative embodiment, the elongated sleeve member 250 may be formed from a piece of thin extruded plastic with a slit, or from a thin molded plastic sleeve. In the illustrative embodiment, the elongated rod section 244 may have a length that is approximately 30 inches, and the elongated sleeve member 250 may have a length that is approximately 8 inches.

In the illustrative embodiment, the drain cleaning device 240 is preferably disposable and can be made of any suitable disposable, recyclable or biodegradable material (e.g., a suitable plastic), such as polyethylene, polystyrene, polycarbonate, acrylic polymer, or nylon. The power tool adapter 10 is preferably reusable and can be made of a suitably durable material (e.g., a suitable plastic) to withstand repeated engagement and disengagement with drain cleaning devices 240 and repeated use.

Referring again to FIG. 18, in the second illustrative embodiment, rather than using the power tool adapter 10 with the drain cleaning device 240, the proximal end portion 242 of the disposable drain cleaning device 240 may be alternatively connected to the distal end portion 262 of a manual handle 260 that allows a user to manually rotate the drain cleaning device 240 without the use of a power tool. Advantageously, in the illustrative embodiment, the proximal end portion 242 of the disposable drain cleaning device 240 may be interchangeably connected with either the distal end portion 16 of the power tool adapter 10 or the distal end portion 262 of a manual handle 260 so that a user may select either powered or manual rotation of the drain cleaning device 240. Like the power tool adapter 10, the manual handle 260 is preferably reusable and can be made of a suitably durable material (e.g., a suitable plastic) to withstand repeated engagement and disengagement with drain cleaning devices 240 and repeated use. As shown in FIG. 18, the manual handle 260 includes an upper handle portion 264, a transverse handle portion 266, and a lower handle portion 268.

It is readily apparent that the aforedescribed power tool adapter 10 for a drain cleaning device offers numerous advantages. For example, the power tool adapter 10 enables a user to utilize the power of a power tool for rotating the drain cleaning device 40, 240 so as to clear sink and tub drain clogs, rather than having to manually manipulate the device 40, 240 by hand. As such, when powered by a drill or other similar rotary motion input device, the drain cleaning assembly 100, 200 effectively cleans a bathroom drain or other type of drain by unblocking the drain of accumulated hair and other debris. The drain cleaning assembly 100, 200 may be used for cleaning drains by removing hair and other debris that is collected in the upper portion of the drain where stopper or strainer mechanisms and other obstructions occur or collected anywhere along the drain pipe down to the bottom elbow bends of the drain where hair and other debris has collected (e.g., in the drain trap). In addition to saving users time and effort, the power tool adapter 10 described herein that is used in conjunction with the drain cleaning device 40, 240 provides the strength and mobility that some disabled users may need to do this common household task rather than calling in a professional.

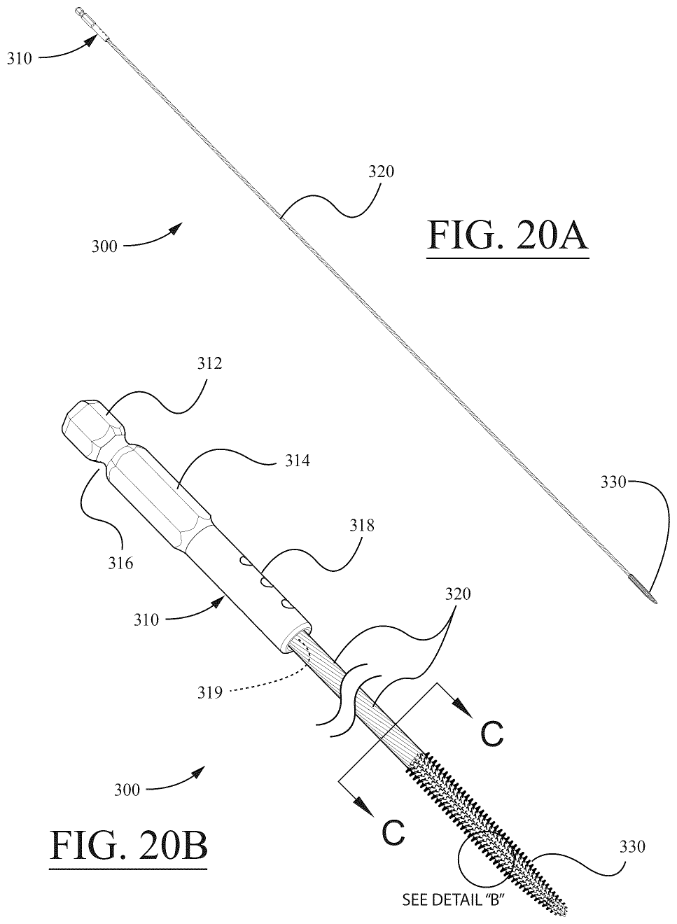

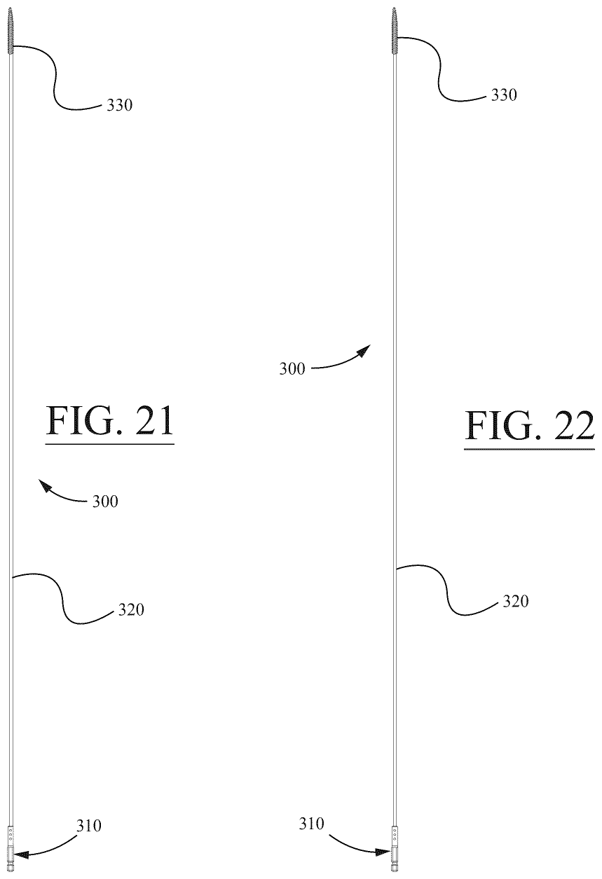

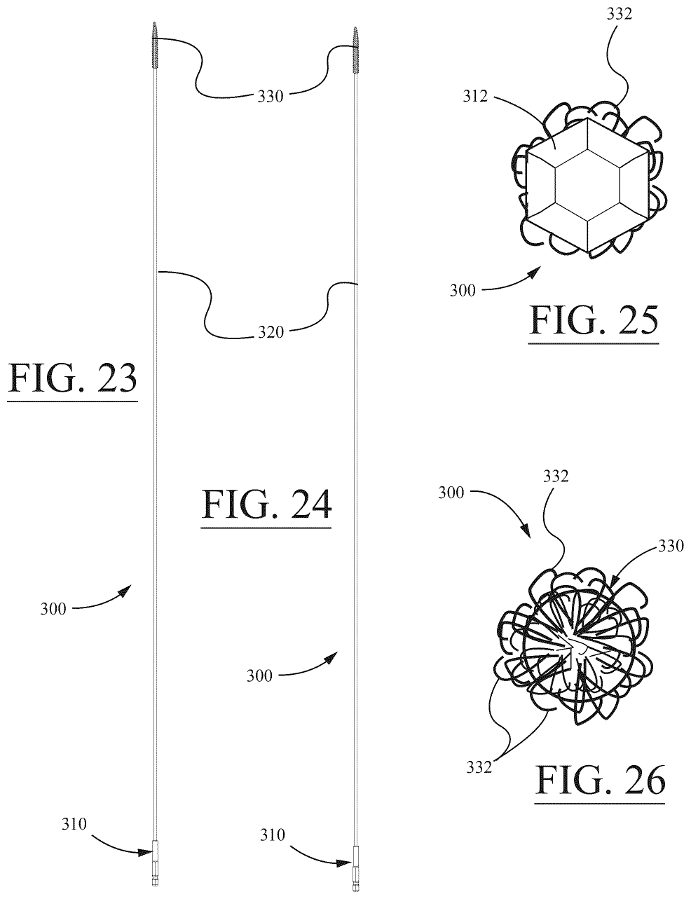

A third illustrative embodiment of a drain cleaning device is seen generally at 300 in FIGS. 20A-29. FIG. 20A shows a perspective view of the illustrative drain cleaning device 300 that includes an elongated shaft 320 having a first end, a second end, and a shaft axis, the first end of the elongated shaft 320 being oppositely disposed relative to the second end of the elongated shaft 320, the elongated shaft 320 further including a plurality of protruding elements projecting outwardly from the elongated shaft 320, the plurality of protruding elements being disposed around a periphery of the elongated shaft 320 at the distal end of the elongated shaft 320. The first end of the elongated shaft 320 is configured to be coupled to a rotary motion input device (e.g., a drill or detachable handle section) that is sufficient to rotate the plurality of protruding elements of the elongated shaft 320 about the shaft axis whereby, upon the elongated shaft 320 being rotated by the rotary motion input device, the plurality of protruding elements are configured to grab and collect debris from a drain pipe.

With combined reference to FIGS. 20A and 20B, it can be seen that the drain cleaning device 300 includes a power tool adapter 310. In the illustrative embodiment, the power tool adapter 310 comprises a drill adapter with a hex-shaped end portion (i.e., a shank section) that goes into the user-provided drill. The drill adapter may be machined or cast from a metal, such as aluminum. For example, the drill adapter may be machined from aluminum and non-anodized. Alternatively, rather than using aluminum, the drill adapter could alternatively be made from a tough plastic, such as polycarbonate or nylon. As shown in FIG. 20B, in the illustrative embodiment, the drill adapter 310 has a cylindrical hole 319 in the bottom thereof where the elongated shaft 320 is inserted. As will be described hereinafter, the elongated shaft 320 (e.g., the snake body) may be formed from multi-strand wire.

Referring to the enlarged view of FIG. 20B, it can be seen that the power tool adapter 310 comprises a first hex-shaped end portion 312 configured to be inserted into a drill chuck recess, an annular recess 316, a second hex-shaped portion 314, and a circular hollow shaft portion 318 with the cylindrical hole 319 formed therein. In an example embodiment, the power tool adapter 310 has an overall length of approximately 55.4 millimeters (mm) and the circular hollow shaft portion 318 of the power tool adapter 310 has an overall length of approximately 30.0 millimeters (mm).

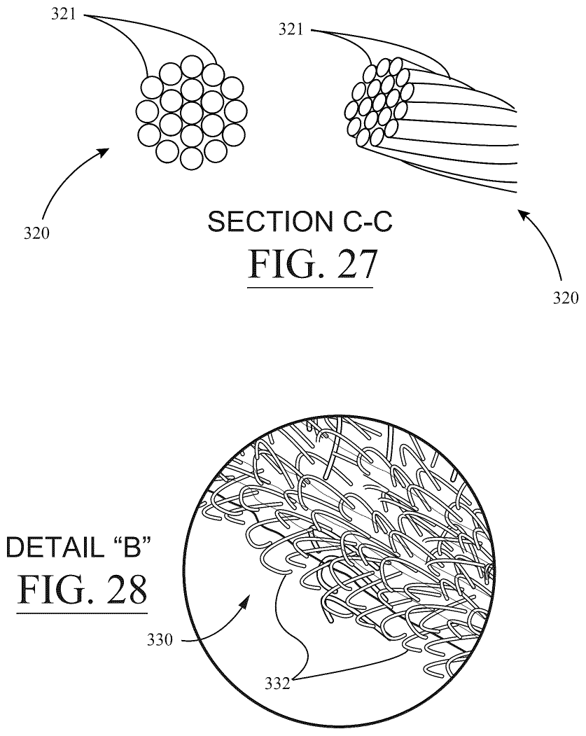

In the illustrative embodiment, referring to FIG. 27, the elongated shaft 320 may be formed from a multi-strand, braided wire (e.g., aviation wire or wire rope). The stiffness of the multi-strand wire is dependent upon the makeup of the stranded wires. There are many types of wire rope, but in one illustrative embodiment, the multi-strand wire is a 7×7 construction (seven (7) bundles of wire 321 of seven (7) wires each wound in either a RHL right hand direction or a LHL (left hand lay) direction. In the illustrative embodiment, the multi-strand wire will be a 7×7 galvanized wire with no plastic coating (to reduce diameter for access to drains with tight stoppers). The multi-strand wire may also in other embodiments be plastic coated to encapsulate the stranded wires and provide additional stiffness and wire protection.

In the illustrative embodiment, referring to the detail in FIG. 28, the plurality of protruding elements at the tip of the drain cleaning device 300 may comprise a hook material strip 330 (e.g., a fabric covering made from the hook portion of Velcro®). Advantageously, the micro-hook tip of the illustrative embodiment formed by the fabric material with myriads of formed hooks 332 (see FIG. 28) is ideal for grappling drain hair and similar fibrous material when the snake is rotated. Alternatively, rather than the hook material strip, the tip of the drain cleaning device 300 could have barbs, a spring, or other grabbing means.

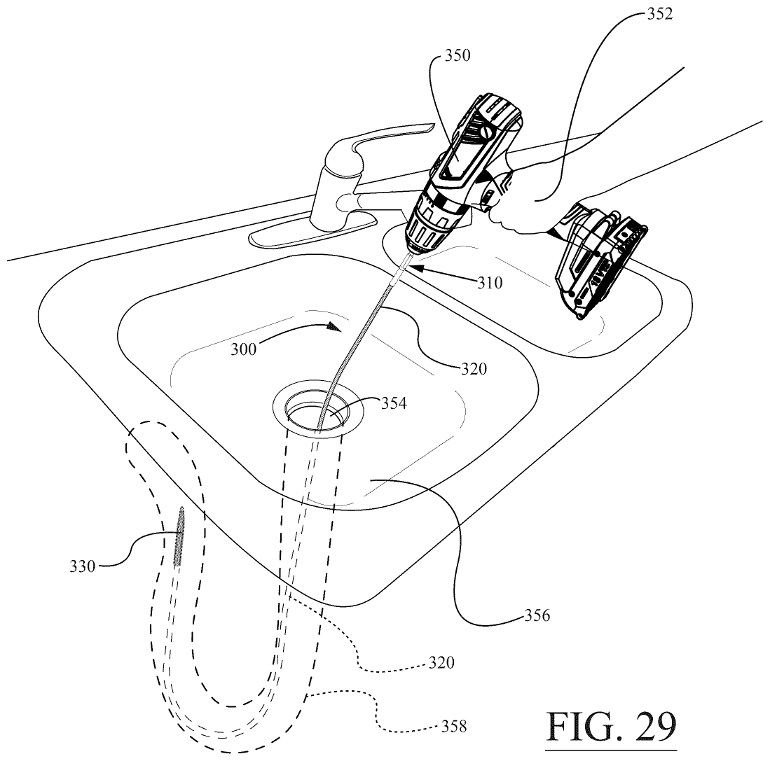

In the illustrative embodiment, during manufacturing, the 7×7 wire cable or rope forming the elongated shaft 320 is cut to length, inserted into the hole 319 in the aluminum drill adapter 310 and then swaged, crimped, or pressed onto the proximal end of the wire cable. In the illustrative embodiment, because LHL (left hand lay) wire cable is used, the drill 350 (see FIG. 29) is ideally run only in a forward direction (i.e. in a direction that would “tighten” the strands rather than “unwind” the strands in the event the snake gets stuck and the user continues to run the drill-similar to spring auger tools directions to run in forward direction to avoid cable damage). Alternatively, a 7×19 wire cable may form the elongated shaft 320. Advantageously, because the wire cable has the feature of wanting to uncoil or spring back like a spring versus staying bent like a single wire snake, the wire cable more easily makes pipe bends than a single wire. The shaft could also be a spring. Advantageously, the wire cable is very strong and flexible in a small diameter to fit down a drain without taking the stopper apart. In the illustrative embodiment, the wire cable forming the elongated shaft 320 may have an approximately ⅛″ outside diameter.

In FIG. 29, an exemplary operation of the drain cleaning device 300 is illustrated. More specifically, FIG. 29 shows the inventive drain cleaning assembly 300 being used in a sink 356 to remove clogging debris from the drain pipe 358 of the sink 356. The sink 356 has an associated faucet for dispensing water into the sink 356. In the illustrative embodiment, the diameter of the elongated shaft 320 of the device 300 is sufficiently narrow to be easily inserted through openings in a typical drain cover all the way to the drain trap, often found in older residential bathrooms or modern drains having pop-up stoppers. Referring again to FIG. 29, after insertion of the elongated shaft 320 into the drain 354, the drain cleaning device 300 is rotated by the drill 350 held by a hand 352 of the user, thus winding into and capturing the clogging debris. The particular construction of the hook elements on the fabric tip section 330 allows the debris to be collected and grabbed by the drain cleaning device 300. After grabbing the clogging debris, the device 300 is removed from the drain 354.

In the illustrative embodiment, a user may insert the elongated shaft 320 of the device 300 into the drain 354 by hand until a pipe bend or obstruction is encountered. Then, the drill 350 is used in a slow to medium speed to spin the elongated shaft 320 of the device 300, which helps “walk” the fabric tip section 330 of the elongated shaft 320 around pipe bends or else winds the tip 330 into the encountered clog for retrieval. While running the drill 350 with one hand, the user may grasp the excess shaft body (glove suggested but not necessary) and provide pressure to push the tip 330 further down the drain 354 or engage the clog. If the device 300 gets “stuck” (i.e. going down one side of the stopper versus the other side) or does not want to advance, the user can withdraw the device 300 and make additional attempts in the same fashion.

In the illustrative embodiment, the drill 350 is used secondarily for its easy rotational ability when needed, but otherwise the device 300 is inserted into the drain and pushed forward with the user's free hand in a manual fashion. Advantageously, in the illustrative embodiment, the elongated shaft 320 of the device 300 is sufficiently thin and flexible so as to have the ability to fit past drain stoppers without drain disassembly, but still have enough stiffness such that the free hand of the user can push it further down the drain.

Advantageously, the drain cleaning device 300 fulfills a need in the market for a mid-range length do-it-yourself (DIY) tool that is not a cumbersome auger and does not require drain disassembly like most augers with ¼″ or larger diameter spring snake bodies.

In the illustrative embodiment, the drain cleaning device 300 may also be rotated using a detachable handle section instead of a drill 350. The detachable handle section will be described in detail in conjunction with the fourth embodiment hereinafter. The detachable handle section may allow the insertion of the same adapter end 310 into the bottom thereof, and the handle may include a sleeve that snaps down over the inserted hex drill adapter end of the device 300 locking the inserted hex drill head into place and allowing the user to manually crank the device 300. In the illustrative embodiment, the user will have to feed the elongated shaft 320 into the drain then pick up the handle and use both hands to hold and spin the elongated shaft 320 of the device 300. In the illustrative embodiment, the detachable handle section is formed from plastic. In other embodiments, the detachable handle section may be formed from metal, such as aluminum.

In the illustrative embodiment, the drain cleaning device 300 comprises a multi-strand wire shaft 320 (in a non-typical LHL direction) with a longer length (e.g., 36 inches, approximately 36 inches, or longer than 36 inches) and crimped drill adapter 310, does not typically require drain disassembly, allows the interchangeable use of a drill or a handle for producing rotary motion, and uses an effective micro-hook tip. In an alternative embodiment, the multi-strand wire shaft 320 could have a length longer than 36 inches.

In alternative embodiments, the drain cleaning device 300 could include removable tips by using a collet-like (e.g., Dremel) tip holder which is swaged onto the wire rope and allows various types of tips to be utilized or else simply being able to dispose of a removable hook material instead of an entire wand.

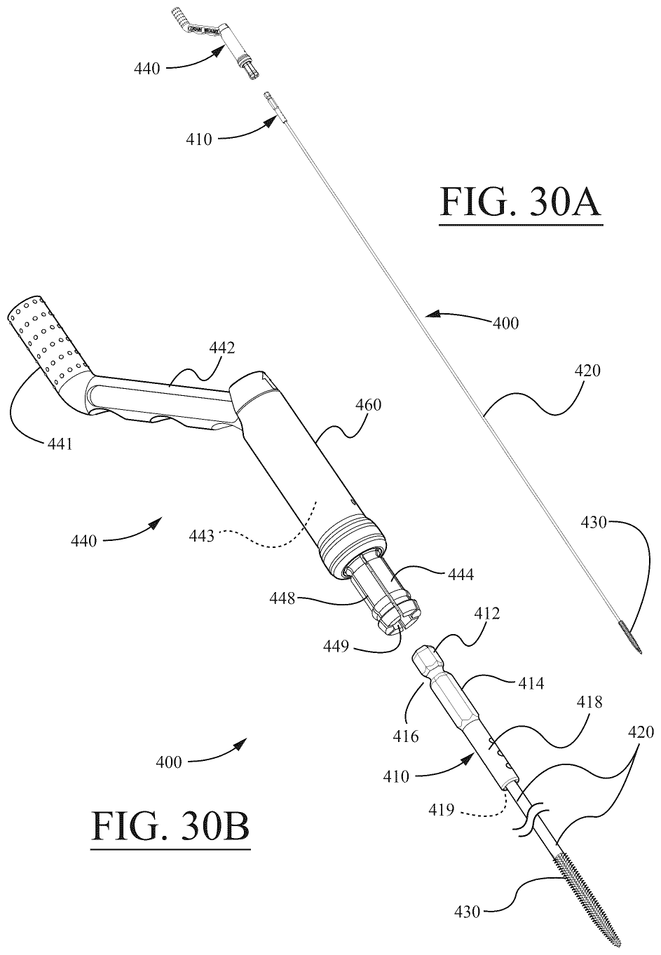

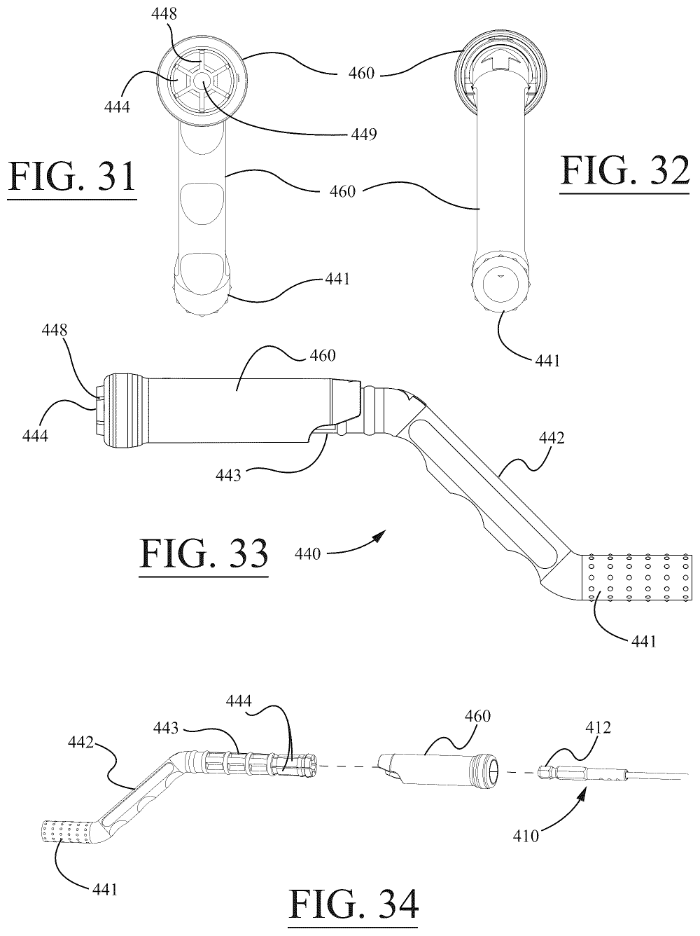

A fourth illustrative embodiment of a drain cleaning device is seen generally at 400 in FIGS. 30A-38. Referring to these figures, it can be seen that, in many respects, the illustrative embodiment of FIGS. 30A-38 is similar to that of the illustrative embodiment of FIGS. 20A-29. Moreover, many elements are common to both such embodiments. For the sake of brevity, the elements that the illustrative embodiment of FIGS. 30A-38 has in common with the embodiment of FIGS. 20A-29 will not be discussed in detail because these components have already been described above.

Similar to that described above for the third illustrative embodiment, the drain cleaning device 400 includes an elongated shaft 420 having a first end, a second end, and a shaft axis, the first end of the elongated shaft 420 being oppositely disposed relative to the second end of the elongated shaft 420, the elongated shaft 420 further including a plurality of protruding elements projecting outwardly from the elongated shaft 420, the plurality of protruding elements being disposed around a periphery of the elongated shaft 420 at the distal end of the elongated shaft 420. The first end of the elongated shaft 420 is configured to be coupled to a rotary motion input device (e.g., a drill or detachable handle section) that is sufficient to rotate the plurality of protruding elements of the elongated shaft 420 about the shaft axis whereby, upon the elongated shaft 420 being rotated by the rotary motion input device, the plurality of protruding elements are configured to grab and collect debris from a drain pipe.

In the fourth illustrative embodiment, similar to the third illustrative embodiment described above, the plurality of protruding elements at the tip of the drain cleaning device 400 may comprise a hook material strip 430 (e.g., a fabric covering made from the hook portion of Velcro®). Advantageously, the micro-hook tip of the illustrative embodiment formed by the fabric material with myriads of formed hooks is ideal for grappling drain hair and similar fibrous material when the snake is rotated. Alternatively, rather than the hook material strip, the tip of the drain cleaning device 400 could have injection-molded micro-hooks, barbs, a spring, or other grabbing means.

Referring to the enlarged view of FIG. 30B, similar to the third illustrative embodiment described above, it can be seen that the power tool adapter 410 comprises a first hex-shaped end portion 412 configured to be inserted into a handle recess or a drill chuck recess, an annular recess 416, a second hex-shaped portion 414, and a circular hollow shaft portion 418 with the cylindrical hole 419 formed therein. In an example embodiment, the power tool adapter 410 has an overall length of approximately 55.4 millimeters (mm) and the circular hollow shaft portion 418 of the power tool adapter 410 has an overall length of approximately 30.0 millimeters (mm).

However, unlike the third illustrative embodiment described above, the elongated shaft 420 of the drain cleaning device 400 is in a form of a plastic shaft, rather than the wire cable shaft of the third illustrative embodiment.

Referring to FIGS. 30A-37, in the fourth illustrative embodiment, rather than being connected to a drill, the hex-shaped end portion 412 of the power tool adapter 410 of the drain cleaning device 400 may be alternatively connected to the distal end portion of a detachable handle section 440. The detachable handle section 440 allows a user to manually rotate the drain cleaning device 400 without the use of a power tool. Advantageously, in the illustrative embodiment, the hex-shaped end portion 412 of the power tool adapter 410 of the drain cleaning device 400 may be interchangeably connected with either a drill or the distal end portion of the detachable handle section 440 so that a user may select either powered or manual rotation of the drain cleaning device 400.

Referring initially to FIG. 30B, it can be seen that the detachable handle section 440 includes a handle body with a handle section 441 for being manually rotated by a user. The drain cleaning device 400 is attached to the detachable handle section 440 by engagement of the proximal end portion (i.e., the end that is closest to the person when operating the device) of the drain cleaning device 400 being engaged with distal end portion of the detachable handle section 440. A slidable sleeve member 460 is shown in its fully engaged configuration in FIG. 36. The sleeve member 460 in this engaged position ensures that the drain cleaning device 400 and the detachable handle section 440 are fully engaged, i.e., interlocked at their corresponding ends, and the device is ready for use, such as for cleaning a drain.

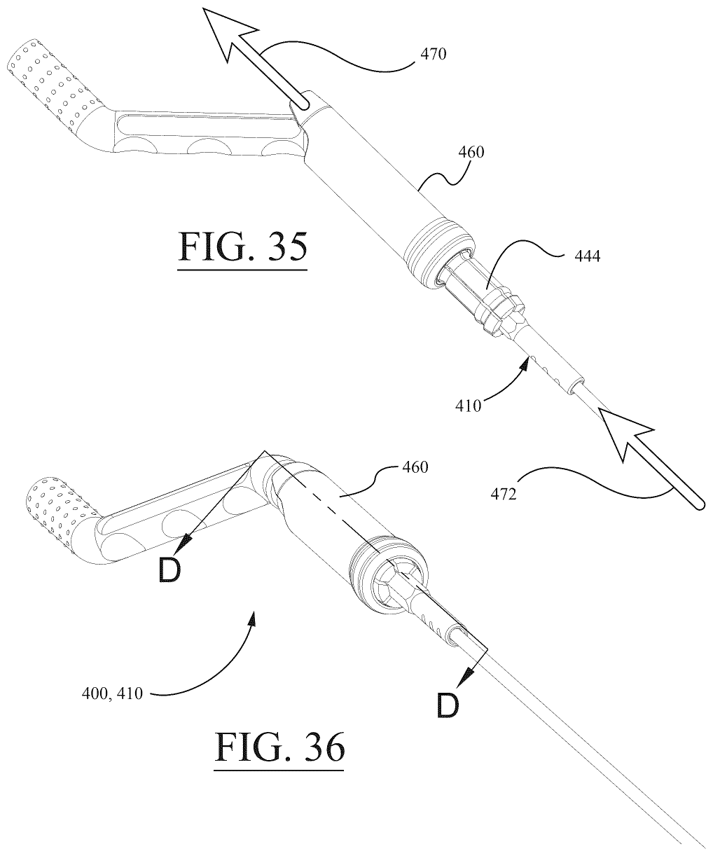

In the illustrative embodiment, referring to the sectional view of FIG. 37, it can be seen that the distal end portion of the detachable handle section 440 comprises a plurality of split arms 444 for grabbing the hex-shaped end portion 412 of the power tool adapter 410 of the drain cleaning device 400. More specifically, as shown in the sectional view of FIG. 37, the hex-shaped end portion 412 of the power tool adapter 410 is configured to be received within a circular recess 449 in the distal end portion of the detachable handle section 440 that is surrounded by the plurality of split arms 444. The split arms 444 are circumferentially arranged and spaced apart from each other by gaps 448 (see FIG. 30B). In the illustrative embodiment, each of the split arms 444 comprises a rounded protrusion 445 that is configured to be received within the annular recess 416 of the power tool adapter 410. As described below, when the slidable sleeve member 460 is in its engaged position, the rounded protrusions 445 of the split arms 444 lock the hex-shaped end portion 412 of the drain cleaning device 400 into the circular recess 449 of the detachable handle section 440. Also, as shown in the sectional view of FIG. 37, each of the split arms 444 are provided with a thinned region 447 to create more flex in the arms 444. The insertion direction of the hex-shaped end portion 412 of the drain cleaning device 400 into the circular recess 449 of the detachable handle section 440 is diagrammatically represented by the arrow 472 in FIG. 35.

In the illustrative embodiment, as shown in FIG. 30B, it can be seen that the handle body of the detachable handle section 440 generally comprises a top cylindrical handle portion 441, bottom cylindrical handle portion 443 and a diagonal transverse middle portion 442 connecting portions 441, 443 that comprises a plurality of finger concave recesses or indentations for accommodating fingers of the user when the drain cleaning device 400 is being inserted into, and removed from a drain.

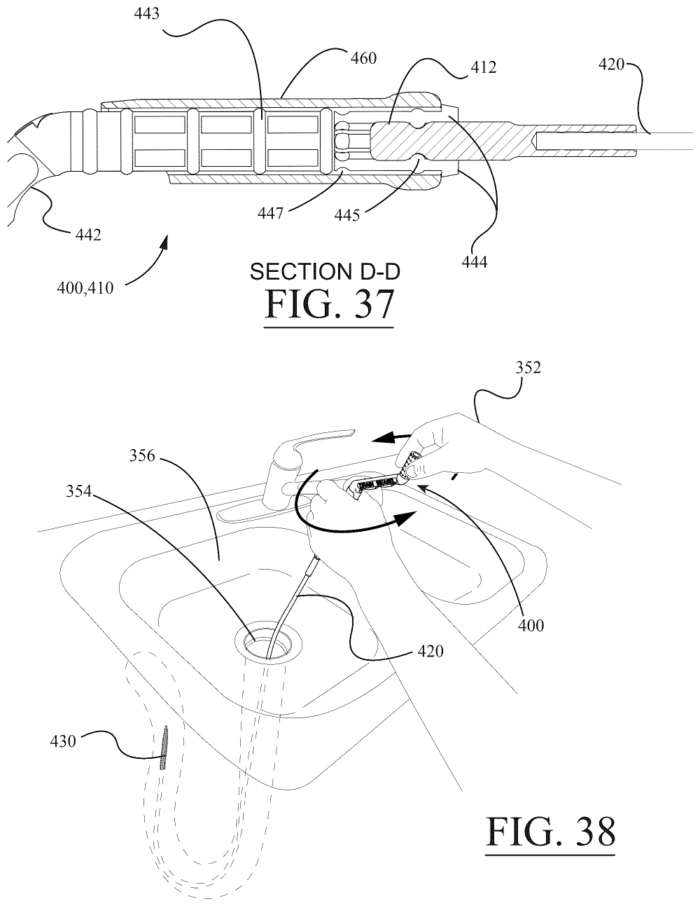

In the illustrative embodiment, the slidable sleeve member 460 moves axially along the center of the bottom cylindrical handle portion 443 of the detachable handle section 440 between an engaged position (i.e., a locking position) and a disengaged position (i.e., a release position). This sliding action of the sleeve member 460 fully engages or releases the drain cleaning device 400. When performing a drain cleaning operation (e.g., as illustrated in FIG. 38), the user grasps the handle portion 441 in one hand 352 and the spinning sleeve member 460 with the other hand, and rotates the drain cleaning device 400 to clean the debris in the drain. The user can then detach the removable drain cleaning device 400 by sliding the spinning sleeve 460 of the manual handle assembly 440 up toward the proximal handle end (in the pointing direction of arrow 470 in FIG. 35), exposing the split arms 444 of the detachable handle section 440 grabbing hex-shaped end portion 412 of the power tool adapter 410 of the drain cleaning device 400, thereby allowing for removal of the drain cleaning device 400 from the detachable handle section 440 (see FIG. 30B).

In the illustrative embodiment, the sleeve member 460 of the detachable handle section 440 can be moved back and forth between two possible positions along the handle body: (i) a disengaged position where the drain cleaning device 400 is able to be released from the detachable handle section 440, and (ii) an engaged position where the distal end portion of the detachable handle section 440 is locked into engagement with the drain cleaning device 400.

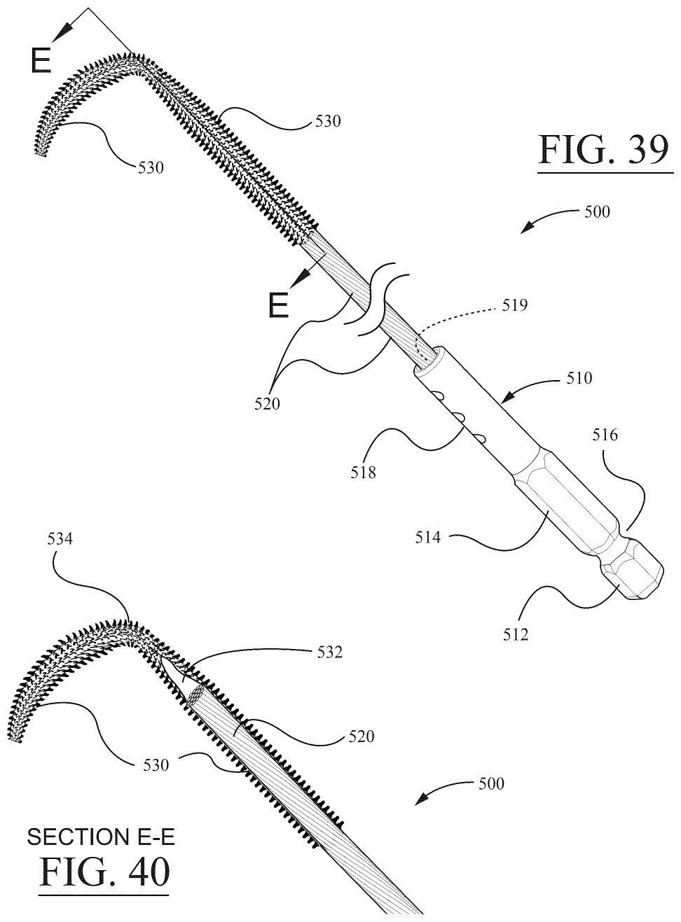

A fifth illustrative embodiment of a drain cleaning device is seen generally at 500 in FIGS. 39 and 40. Referring to these figures, it can be seen that, in many respects, the illustrative embodiment of FIGS. 39 and 40 is similar to that of the third and fourth illustrative embodiments described above. Moreover, many elements are common to both such embodiments. For the sake of brevity, the elements that the illustrative embodiment of FIGS. 39 and 40 has in common with the third and fourth illustrative embodiments will not be discussed in detail because these components have already been described above.

Similar to that described above for the third and fourth illustrative embodiments, the drain cleaning device 500 includes an elongated shaft 520 having a first end, a second end, and a shaft axis, the first end of the elongated shaft 520 being oppositely disposed relative to the second end of the elongated shaft 520, the elongated shaft 520 further including a plurality of protruding elements projecting outwardly from the elongated shaft 520, the plurality of protruding elements being disposed around a periphery of the elongated shaft 520 at the distal end of the elongated shaft 520. The first end of the elongated shaft 520 is configured to be coupled to a rotary motion input device (e.g., a drill or detachable handle section) that is sufficient to rotate the plurality of protruding elements of the elongated shaft 520 about the shaft axis whereby, upon the elongated shaft 520 being rotated by the rotary motion input device, the plurality of protruding elements are configured to grab and collect debris from a drain pipe.

In the fifth illustrative embodiment, similar to the third and fourth illustrative embodiments described above, the plurality of protruding elements at the tip of the drain cleaning device 500 may comprise a hook material strip 530 (e.g., a fabric covering made from the hook portion of Velcro®). Advantageously, the micro-hook tip of the illustrative embodiment formed by the fabric material with myriads of formed hooks is ideal for grappling drain hair and similar fibrous material when the snake is rotated. Alternatively, rather than the hook material strip, the tip of the drain cleaning device 500 could have injection-molded micro-hooks, barbs, a spring, or other grabbing means.

Referring to the enlarged view of FIG. 39, similar to the third and fourth illustrative embodiments described above, it can be seen that the power tool adapter 510 comprises a first hex-shaped end portion 512 configured to be inserted into a drill chuck recess or handle recess, an annular recess 516, a second hex-shaped portion 514, and a circular hollow shaft portion 518 with the cylindrical hole 519 formed therein. In an example embodiment, the power tool adapter 510 has an overall length of approximately 55.4 millimeters (mm) and the circular hollow shaft portion 518 of the power tool adapter 510 has an overall length of approximately 30.0 millimeters (mm).

However, unlike the third and fourth illustrative embodiments described above, the hook material strip 530 of the drain cleaning device 500 in FIGS. 39 and 40 has an extended length portion 534 (i.e., a flopped over end portion 534 with void 532 defined therein) that ends beyond the distal end of the elongated shaft 520 (e.g., the hook material strip 530 may extend approximately ½″ beyond the end of the wire cable of the drain cleaning device 500). Advantageously, the extended length portion of the hook material strip 530 that is unsupported by the elongated shaft 520 makes the end of the drain cleaning device 500 more flexible so that it jumps over obstructions in the drain and helps navigate bends easier.

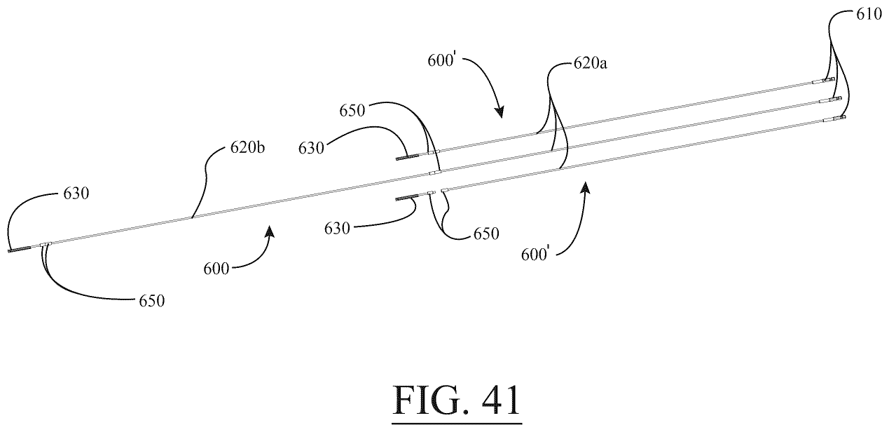

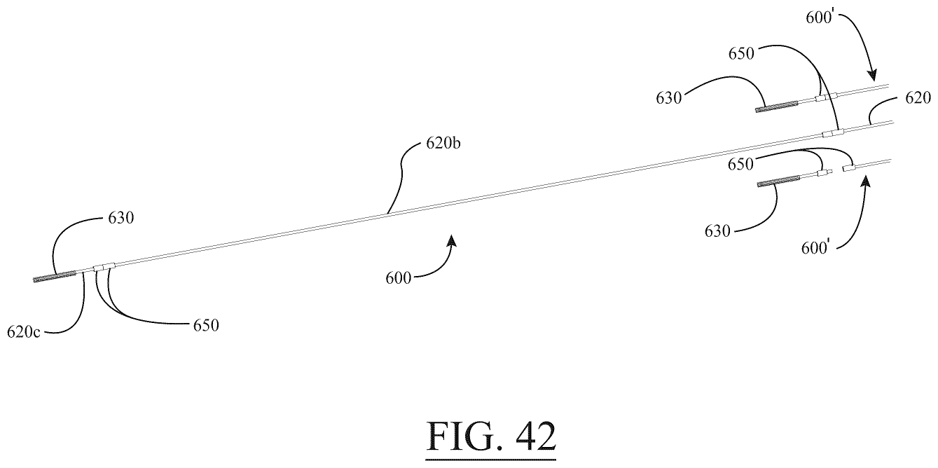

A sixth illustrative embodiment of a drain cleaning device is seen generally at 600, 600′ in FIGS. 41-43. Referring to these figures, it can be seen that, in many respects, the illustrative embodiment of FIGS. 41-43 is similar to that of the preceding illustrative embodiments. Moreover, many elements are common to all of these embodiments. For the sake of brevity, the elements that the illustrative embodiment of FIGS. 41-43 has in common with the preceding embodiments will not be discussed in detail because these components have already been described above.

Similar to that described above for the preceding illustrative embodiments, the drain cleaning device 600 includes an elongated shaft 620a, 620b, 620c having a first end, a second end, and a shaft axis, the first end of the elongated shaft 620a, 620b, 620c being oppositely disposed relative to the second end of the elongated shaft 620a, 620b, 620c, the elongated shaft 620a, 620b, 620c further including a plurality of protruding elements projecting outwardly from a tip of the elongated shaft 620a, 620b, 620c, the plurality of protruding elements being disposed around a periphery of the elongated shaft 620a, 620b, 620c at the distal end of the elongated shaft 620a, 620b, 620c. The first end of the elongated shaft 620a, 620b, 620c is configured to be coupled to a rotary motion input device (e.g., a drill or detachable handle section) that is sufficient to rotate the plurality of protruding elements of the elongated shaft 620a, 620b, 620c about the shaft axis whereby, upon the elongated shaft 620a, 620b, 620c being rotated by the rotary motion input device, the plurality of protruding elements are configured to grab and collect debris from a drain pipe.

In the sixth illustrative embodiment, similar to the preceding illustrative embodiments described above, the plurality of protruding elements at the tip of the drain cleaning device 600, 600′ may comprise a hook material strip 630 (e.g., a fabric covering made from the hook portion of Velcro®). Advantageously, the micro-hook tip of the illustrative embodiment formed by the fabric material with myriads of formed hooks is ideal for grappling drain hair and similar fibrous material when the snake is rotated. Alternatively, rather than the hook material strip, the tip of the drain cleaning device 600, 600′ could have injection-molded micro-hooks, barbs, a spring, or other grabbing means.

Referring to the perspective view of FIG. 41, similar to the preceding illustrative embodiments described above, the power tool adapter 610 comprises a first hex-shaped end portion configured to be inserted into a drill chuck recess, an annular recess, a second hex-shaped portion, and a circular hollow shaft portion with the cylindrical hole formed therein. In an example embodiment, the power tool adapter 610 has an overall length of approximately 55.4 millimeters (mm) and the circular hollow shaft portion of the power tool adapter 610 has an overall length of approximately 30.0 millimeters (mm).

However, unlike the preceding illustrative embodiments described above, the drain cleaning device 600, 600′ has an elongated shaft formed from longitudinal sections 620a, 620b, 620c that connect together using extension couplers or connection fittings 650 in order to increase the overall length of the drain cleaning device 600, 600′. Like the third illustrative embodiment described above, the elongated shaft 620a, 620b, 620c of the drain cleaning device 600, 600′ is formed from wire cable or rope (e.g., aircraft cable), but may include several longitudinal sections (e.g., longitudinal sections having a three (3) foot length or approximately three (3) foot length) that screw or otherwise connect together to increase the overall length of the drain cleaning device 600, 600′. In the illustrative embodiment, the tip longitudinal section 620c comprising the hook material strip 630 may be disposable, while the other longitudinal sections 620a, 620b may be reusable. The tip longitudinal section 620c screws or otherwise connects onto the end in the same manner as the other longitudinal sections 620a, 620b. In the illustrative embodiment, the drain cleaning device 600, 600′ may be provided as part of a kit that includes two (2) or three (3) tip longitudinal sections 620c.

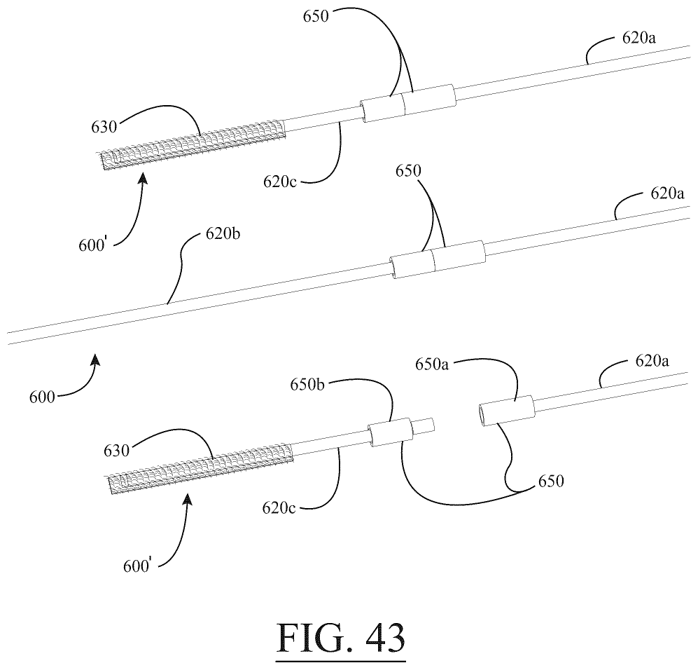

In the illustrative embodiment of FIGS. 41-43, the extension couplers 650 that connect the longitudinal section 620a to longitudinal section 620b, and that connect the longitudinal section 620a, 620b to the tip longitudinal section 620c, are threaded so that the longitudinal sections 620a, 620b, 620c simply screw together using the threads of the extension couplers 650. For example, as shown in FIG. 43, the extension coupler female portion 650a may comprise internal threads that threadingly engage with corresponding external threads on the extension coupler male portion 650b. In another embodiment, as an alternative to the threads, the extension couplers 650 may use a spring and pin type locking arrangement for connecting the longitudinal sections 620a, 620b, 620c to one another.

Similar to the preceding illustrative embodiments described above, the adapter 610 of the drain cleaning device 600, 600′ is configured to be selectively attached to either a manual handle (see FIG. 30B) or a power drill (see FIG. 29) by a user. In the illustrative embodiment, the longitudinal sections 620a, 620b, 620c connect together in order to achieve an overall length desired by a user of the drain cleaning device 600, 600′. In the illustrative embodiment, the tip longitudinal section 620c may be removable and disposable so that the tip longitudinal section 620c may be removed and thrown away after the drain cleaning device 600, 600′ is used to clean a drain and/or pipe. Then, a new tip longitudinal section 620c can be installed on the remainder of the drain cleaning device 600, 600′ that is reusable. Advantageously, the drain cleaning device 600, 600′ does not contain any heavy and/or unwieldy spring canister that is present in traditional augers. Rather, when using the drain cleaning device 600, 600′, user initially feeds one section down the drain, and then installs the next section, and feeds the next section down the drain (and so on and so forth). Like the third illustrative embodiment described above, the elongated shaft 620a, 620b, 620c of the drain cleaning device 600, 600′ is formed from wire cable or rope (e.g., aircraft cable) because of its small diameter and high strength. Alternatively, the drain cleaning device 600, 600′ could be formed from a spring. Advantageously, the small cross-sectional diameter of the drain cleaning device 600, 600′ obviates the need for taking apart the drain when using the device 600, 600′.

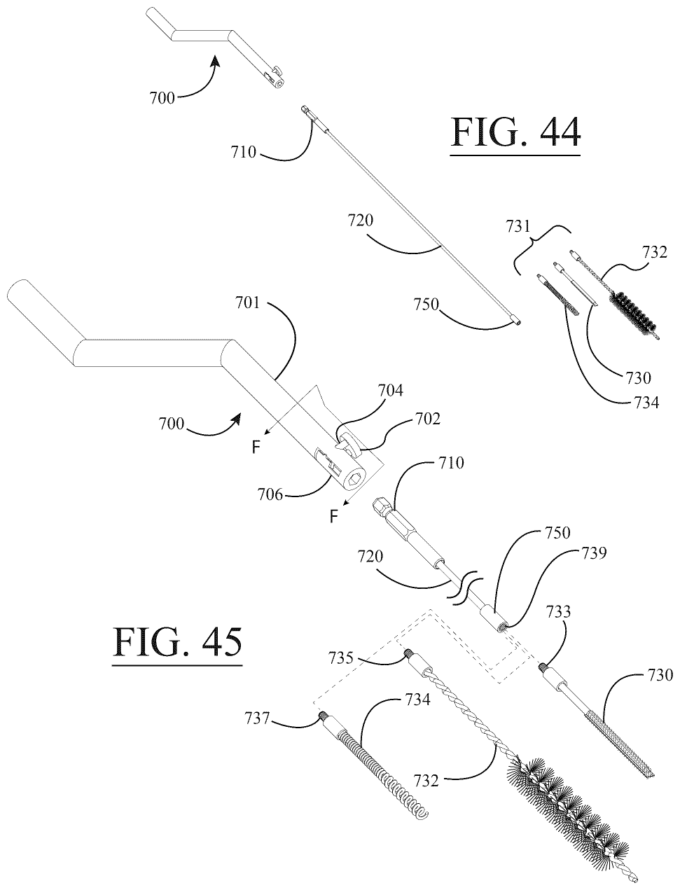

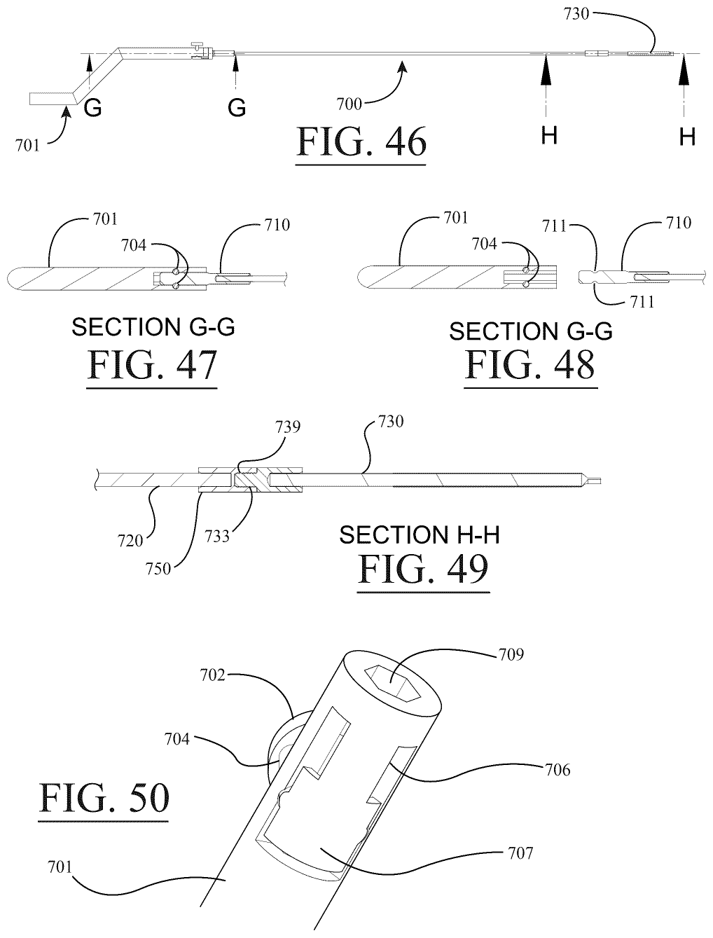

A seventh illustrative embodiment of a drain cleaning device is seen generally at 700 in FIGS. 44-53. Referring to these figures, it can be seen that, in many respects, the illustrative embodiment of FIGS. 44-53 is similar to that of the preceding illustrative embodiments. Moreover, many elements are common to all of these embodiments. For the sake of brevity, the elements that the illustrative embodiment of FIGS. 44-53 has in common with the preceding embodiments will not be discussed in detail because these components have already been described above.

Similar to that described above for the preceding illustrative embodiments, referring to FIGS. 44 and 45, the drain cleaning device 700 includes a power tool adapter 710 and an elongated shaft 720 having a first end, a second end, and a shaft axis, the first end of the elongated shaft 720 being oppositely disposed relative to the second end of the elongated shaft 720, the elongated shaft 720 further including a plurality of protruding elements projecting outwardly from a tip of the elongated shaft 720, the plurality of protruding elements being disposed around a periphery of the elongated shaft 720 at the distal end of the elongated shaft 720. The first end of the elongated shaft 720 is configured to be coupled to a rotary motion input device (e.g., a drill or detachable handle section) that is sufficient to rotate the plurality of protruding elements of the elongated shaft 720 about the shaft axis whereby, upon the elongated shaft 720 being rotated by the rotary motion input device, the plurality of protruding elements are configured to grab and collect debris from a drain pipe.

In the seventh illustrative embodiment, referring to FIGS. 44 and 45, it can be seen that various types of tips 731 can be used with the drain cleaning device 700. Similar to the preceding illustrative embodiments described above, the first tip type 730 may comprise a hook material strip (e.g., a fabric covering made from the hook portion of Velcro®) that forms the plurality of protruding elements on the tip. Advantageously, the micro-hook tip of the illustrative embodiment formed by the fabric material with myriads of formed hooks is ideal for grappling drain hair and similar fibrous material when the snake is rotated. Alternatively, rather than the hook material strip, the tip of the drain cleaning device 700 could have injection-molded micro-hooks, barbs, a spring, or other grabbing means.

With reference again to FIGS. 44 and 45, it can be seen that the second tip type 732 may comprise a steel brush tip with bristles, while the third tip type 734 may comprise a spiral spring-shaped tip. In the illustrative embodiment, the drain cleaning device 700 may be provided as part of a kit that includes the three (3) different types of tips 730, 732, 734. In the illustrative embodiment, one or more of the tips 730, 732, 734 may be disposable, while the remainder of the drain cleaning device 700 may be reusable.

Referring to FIGS. 44, 45, and 51, similar to the preceding illustrative embodiments described above, the power tool adapter 710 of the drain cleaning device 700 comprises a first hex-shaped end portion configured to be inserted into a drill chuck recess, an annular recess 711, a second hex-shaped portion, and a circular hollow shaft portion with the cylindrical hole formed therein. In an example embodiment, the power tool adapter 710 has an overall length of approximately 55.4 millimeters (mm) and the circular hollow shaft portion of the power tool adapter 710 has an overall length of approximately 30.0 millimeters (mm).

In the seventh illustrative embodiment, similar to the preceding illustrative embodiments described above, the elongated shaft 720 of the drain cleaning device 700 may be formed from a wire cable or rope (e.g., aircraft cable). Alternatively, the elongated shaft 720 of the drain cleaning device 700 may be in a form of a plastic shaft, rather than a wire cable shaft.

With reference again to FIGS. 44 and 45, in the seventh illustrative embodiment, the connection fittings that connect the tips 730, 732, 734 to the elongated shaft 720 are threaded so that the tips 730, 732, 734 threadingly engage with the distal end of the elongated shaft 720. For example, as shown in FIG. 45, the connection fitting female portion 750 on the distal end of the elongated shaft 720 may comprise internal threads 739 that threadingly engage with corresponding external threads 733, 735, 737 on a respective one of the connection fitting male portions on the tips 730, 732, 734. In another embodiment described hereinafter, as an alternative to the threads, the connection fitting may be in a form of a push-style connection fitting for connecting the tips 730, 732, 734 to the distal end of the elongated shaft 720.

Similar to the preceding illustrative embodiments described above, the adapter 710 of the drain cleaning device 700 is configured to be selectively attached to either a manual handle (see FIGS. 44 and 45) or a power drill (see FIG. 29) by a user. Referring initially to FIG. 45, it can be seen that the detachable handle section includes a handle body 701 with a handle section for being manually rotated by a user. The drain cleaning device 700 is attached to the detachable handle section by engagement of the proximal end portion (i.e., the end that is closest to the person when operating the device) of the drain cleaning device 700 being engaged with distal end portion of the handle body 701. A pushbutton locking mechanism 702, 704 is used to selectively engage and disengage the proximal end portion of the drain cleaning device 700.

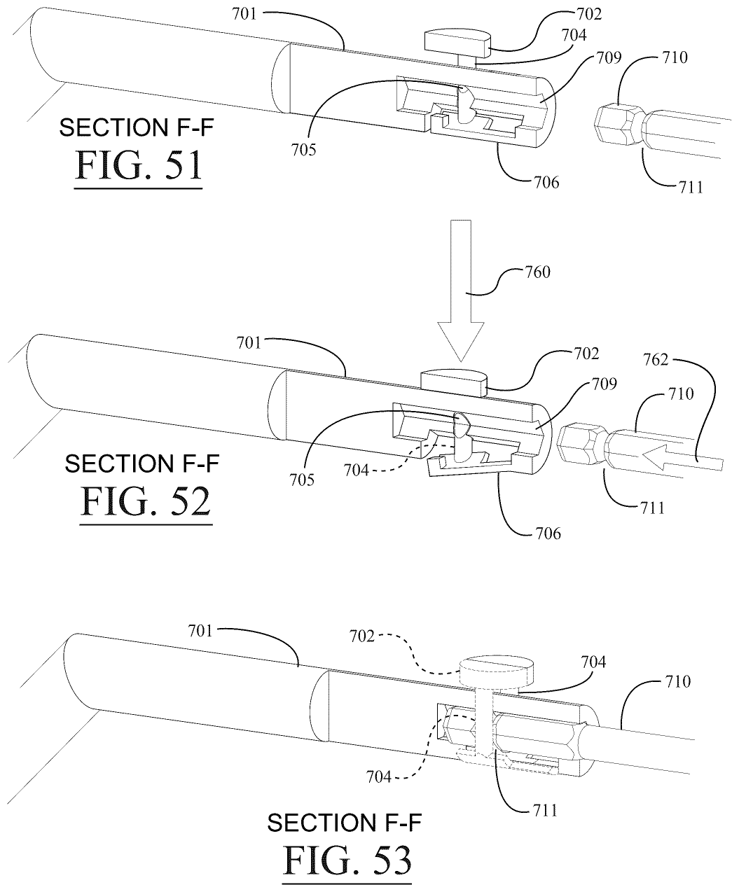

With combined reference to FIGS. 45, 50, and 51, in the illustrative embodiment, it can be seen that the pushbutton locking mechanism 702, 704 on the handle body 701 comprises a pushbutton disk portion 702 and a pair of cylindrical members 704 extending downwardly from the pushbutton disk portion 702. In FIG. 51, the pushbutton disk portion 702 on the handle body 701 has not yet been depressed by a user, and the power tool adapter 710 of the drain cleaning device 700 is in a disengaged position. Then, turning to FIG. 52, the pushbutton disk portion 702 on the handle body 701 has been depressed by a user (as diagrammatically indicated by the downward arrow 760), and the power tool adapter 710 of the drain cleaning device 700 is about to be inserted into the hexagonal aperture 709 on the distal end of the handle body 701 (as diagrammatically indicated by the arrow 762). As shown in FIG. 52, when the pushbutton disk portion 702 is depressed by a user, the pair of cylindrical members 704 push against the displaceable tab portion 707 on the handle body 701 such that the displaceable tab portion 707 is displaced downwardly so as to allow the angled notches 705 in the pair of cylindrical members 704 to be aligned with opposed sides of the hexagonal aperture 709 extending longitudinally through the handle body 701, thereby allowing the first hex-shaped end portion of the power tool adapter 710 to slide past the pair of cylindrical members 704 to the position shown in FIG. 53. As shown in FIGS. 50 and 52, the displaceable tab portion 707 is connected to the handle body 701 by the bendable neck portion 706, which has a reduced width, so as to facilitate a flexing of the bendable neck portion 706 when the displaceable tab portion 707 is displaced downwardly to the position depicted in FIG. 52. Finally, as shown in FIGS. 47 and 53, the power tool adapter 710 of the drain cleaning device 700 has been fully inserted into the hexagonal aperture 709 of the handle body 701, and the adapter 710 has been locked in place by the pair of cylindrical members 704 extending downwardly from the pushbutton disk 702 of the handle section. As shown in FIG. 53, once the adapter 710 has been fully inserted into the hexagonal aperture 709 of the handle body 701, the displaceable tab portion 707 pushes the pair of cylindrical members 704 back into their undisplaced positions where the angled notches 705 are no longer aligned with opposed sides of the hexagonal aperture 709, thus trapping the adapter 710 in place within the handle body 701 by means of the pair of cylindrical members 704 being disposed within the annular recess 711 of the adapter 710 (see FIGS. 47 and 53). In the locked position of FIGS. 47 and 53, the power tool adapter 710 of the drain cleaning device 700 is not able to be pulled out of the hexagonal aperture 709 of the handle body 701 unless the pushbutton disk 702 is depressed by a user so as to align the angled notches 705 in the pair of cylindrical members 704 with opposed sides of the hexagonal aperture 709.

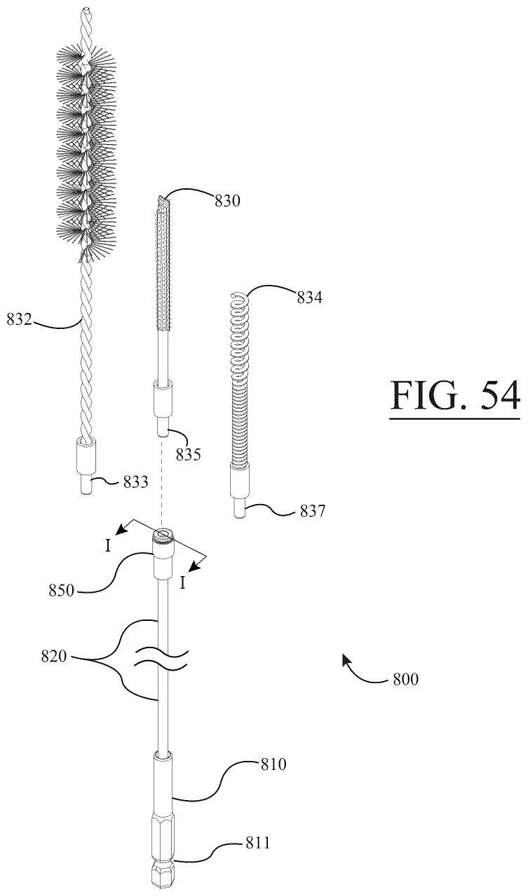

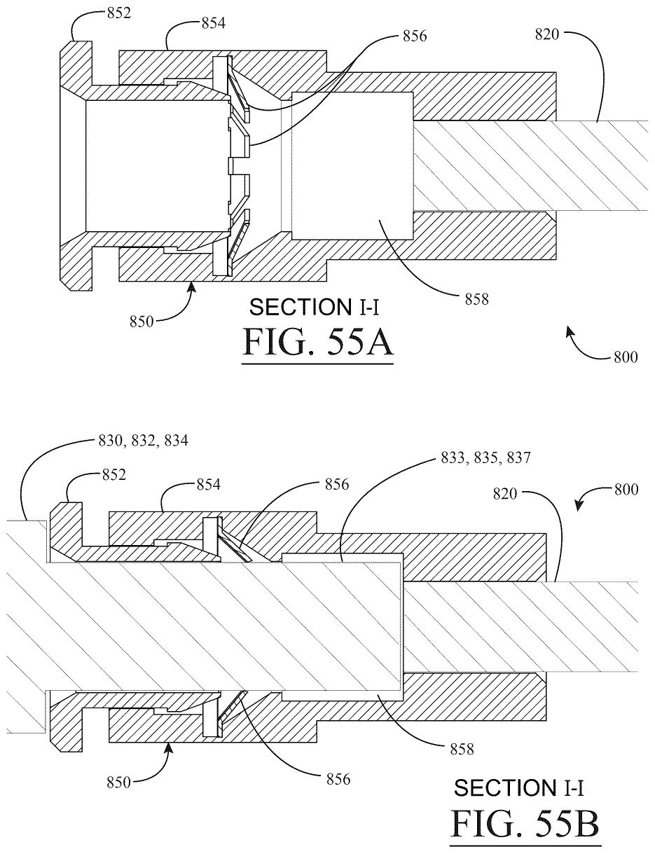

An eighth illustrative embodiment of a drain cleaning device is seen generally at 800 in FIGS. 54-55B. Referring to these figures, it can be seen that, in many respects, the illustrative embodiment of FIGS. 54-55B is similar to that of the preceding illustrative embodiments. Moreover, many elements are common to all of these embodiments. For the sake of brevity, the elements that the illustrative embodiment of FIGS. 54-55B has in common with the preceding embodiments will not be discussed in detail because these components have already been described above.

Similar to that described above for the preceding illustrative embodiments, referring to FIG. 54, the drain cleaning device 800 includes a power tool adapter 810 and an elongated shaft 820 having a first end, a second end, and a shaft axis, the first end of the elongated shaft 820 being oppositely disposed relative to the second end of the elongated shaft 820, the elongated shaft 820 further including a plurality of protruding elements projecting outwardly from a tip of the elongated shaft 820, the plurality of protruding elements being disposed around a periphery of the elongated shaft 820 at the distal end of the elongated shaft 820. The first end of the elongated shaft 820 is configured to be coupled to a rotary motion input device (e.g., a drill or detachable handle section) that is sufficient to rotate the plurality of protruding elements of the elongated shaft 820 about the shaft axis whereby, upon the elongated shaft 820 being rotated by the rotary motion input device, the plurality of protruding elements are configured to grab and collect debris from a drain pipe.

In the eighth illustrative embodiment, referring to FIG. 54, it can be seen that various types of tips 830, 832, 834 can be used with the drain cleaning device 800. Similar to the preceding illustrative embodiments described above, the first tip type 830 may comprise a hook material strip (e.g., a fabric covering made from the hook portion of Velcro®) that forms the plurality of protruding elements on the tip. Advantageously, the micro-hook tip of the illustrative embodiment formed by the fabric material with myriads of formed hooks is ideal for grappling drain hair and similar fibrous material when the snake is rotated. Alternatively, rather than the hook material strip, the tip of the drain cleaning device 800 could have injection-molded micro-hooks, barbs, a spring, or other grabbing means.

With reference again to FIG. 54, it can be seen that the second tip type 832 may comprise a steel brush tip with bristles, while the third tip type 834 may comprise a spiral spring-shaped tip. In the illustrative embodiment, the drain cleaning device 800 may be provided as part of a kit that includes the three (3) different types of tips 830, 832, 834. In the illustrative embodiment, one or more of the tips 830, 832, 834 may be disposable, while the remainder of the drain cleaning device 800 may be reusable.

Referring again to FIG. 54, similar to the preceding illustrative embodiments described above, the power tool adapter 810 of the drain cleaning device 800 comprises a first hex-shaped end portion configured to be inserted into a drill chuck recess, an annular recess 811, a second hex-shaped portion, and a circular hollow shaft portion with the cylindrical hole formed therein. In an example embodiment, the power tool adapter 810 has an overall length of approximately 55.4 millimeters (mm) and the circular hollow shaft portion of the power tool adapter 810 has an overall length of approximately 30.0 millimeters (mm).

In the eighth illustrative embodiment, similar to the preceding illustrative embodiments described above, the elongated shaft 820 of the drain cleaning device 800 may be formed from a wire cable or rope (e.g., aircraft cable). Alternatively, the elongated shaft 820 of the drain cleaning device 800 may be in a form of a plastic shaft, rather than a wire cable shaft.

However, unlike the preceding illustrative embodiments described above, the connection fittings that connect the tips 830, 832, 834 to the elongated shaft 820 are not threaded. Rather, referring initially to FIG. 54 of the eighth illustrative embodiment, it can be seen that the connection fitting that connects the tips 830, 832, 834 to the elongated shaft 820 is in a form of a push-style connection fitting. For example, as shown in FIG. 54, a non-threaded connection fitting female portion 850 is provided on the distal end of the elongated shaft 820 that engages with a respective one of the non-threaded connection fitting male portions 833, 835, 837 on the tips 830, 832, 834. In the illustrative embodiment, the non-threaded connection fitting female portion 850 on the distal end of the elongated shaft 820 is in a form of a quick-release connector head, and the non-threaded connection fitting male portions 833, 835, 837 of the tips 830, 832, 834 are in a form of cylindrical tip end portions.

Similar to the preceding illustrative embodiments described above, the adapter 810 of the drain cleaning device 800 is configured to be selectively attached to either a manual handle (see e.g., FIGS. 44 and 45) or a power drill (see e.g., FIG. 29) by a user.

Now, turning to FIG. 55A, the quick-release connector head 850 on the distal end of the elongated shaft 820 will be described in further detail. As shown in the illustrative embodiment of FIG. 55A, the quick-release connector head 850 comprises a displaceable collar member 852, a housing portion 854, a plurality of locking barb members 856 (e.g., small metal barbs), and an internal cavity 858. The displaceable collar member 852 is able to be longitudinally displaced along a longitudinal axis of the elongated shaft 820. When pressed inwardly towards the housing portion 854 by a user, the wedge-shaped end of the displaceable collar member 852 is configured to displace the plurality of locking barb members 856 radially outward so that a connection fitting male portion 833, 835, 837 is able to be inserted into the internal cavity 858 of the quick-release connector head 850 (see FIG. 55B). When the displaceable collar member 852 is released by the user, the plurality of locking barb members 856 engage with an outer periphery of the connection fitting male portion 833, 835, 837 so as to lock the tip 830, 832, 834 in place on the elongated shaft 820. For example, the locking barb members 856 may dig into, or partially embed within the outer periphery of the connection fitting male portion 833, 835, 837 so as to prevent the tip 830, 832, 834 from being pulled out of the distal end of the elongated shaft 820, as well as prevent the connection fitting male portion 833, 835, 837 of the tip 830, 832, 834 from spinning within the internal cavity 858 of the quick-release connector head 850. For example, in the illustrative embodiment, the connection fitting male portion 833, 835, 837 of each tip 830, 832, 834 may be formed from a deformable plastic material that allows the locking barb members 856 (e.g., small metal barbs) to dig into the outer periphery of the connection fitting male portion 833, 835, 837. In the illustrative embodiment, if a user tries to pull the tip 830, 832, 834 out of the distal end of the elongated shaft 820 when the locking barb members 856 are engaged, the locking barb members 856 will dig into the outer periphery of the connection fitting male portion 833, 835, 837 even more to prevent the removal of the tip 830, 832, 834 from the elongated shaft 820.

In the illustrative embodiment, to release the tip 830, 832, 834 from the distal end of the elongated shaft 820, a user simply presses the displaceable collar member 852 inwardly towards the housing portion 854, thereby releasing the plurality of locking barb members 856 from the outer periphery of the connection fitting male portion 833, 835, 837, and allowing the tip 830, 832, 834 to be removed from the elongated shaft 820.

Advantageously, in the eighth illustrative embodiment, the non-threaded barbed connection fitting described above allows a drill driving the drain cleaning device 800 to be operated in either direction (i.e., in either forward or reverse) without resulting in disengaging the tips 830, 832, 834 from the distal end of the elongated shaft 820.

It is readily apparent that the aforedescribed drain cleaning device 300, 400, 500, 600, 600′, 700, 800 offers numerous advantages. For example, the ultra-slim design allows the drain cleaning device 300, 400, 500, 600, 600′, 700, 800 to fit down tight drain openings. Using either the detachable handle or a power drill, the tiny micro hooks of the tip of the drain cleaning device 300, 400, 500, 600, 600′, 700, 800 are spun 360 degrees, thus “locking” them into tough hair clogs. Advantageously, the two-hundred (200) or more micro-hooks of the illustrative drain cleaning device 300, 400, 500, 600, 600′, 700, 800 do not get caught on drain parts. Also, advantageously, the drain cleaning device 300, 400, 500, 600, 600′, 700, 800 is suitable for non-professional DIY users that do not want to use a cumbersome “auger” type drain snake but would like a lighter, easier to use, and cheaper device that is longer (e.g., 36 inches long) than typical inexpensive stick-like plastic devices that are available in the market.

Any of the features or attributes of the above described embodiments and variations can be used in combination with any of the other features and attributes of the above described embodiments and variations as desired.

Although the invention has been shown and described with respect to a certain embodiment or embodiments, it is apparent that this invention can be embodied in many different forms and that many other modifications and variations are possible without departing from the spirit and scope of this invention.

Moreover, while exemplary embodiments have been described herein, one of ordinary skill in the art will readily appreciate that the exemplary embodiments set forth above are merely illustrative in nature and should not be construed as to limit the claims in any manner. Rather, the scope of the invention is defined only by the appended claims and their equivalents, and not, by the preceding description.

The invention claimed is:

1. A drain cleaning device for removing debris from a drain, the drain cleaning device comprising:
an elongated shaft having a first end, a second end, and a shaft axis, the first end of the elongated shaft being oppositely disposed relative to the second end of the elongated shaft, the elongated shaft further including a plurality of protruding elements projecting outwardly from the elongated shaft, the plurality of protruding elements being disposed at least partially around a periphery of the elongated shaft and along at least a portion of a length of the elongated shaft between the first end and the second end;
wherein the first end of the elongated shaft is configured to be coupled to a rotary motion input device that is sufficient to rotate the plurality of protruding elements of the elongated shaft about the shaft axis; and
whereby, upon the elongated shaft being rotated by the rotary motion input device, the plurality of protruding elements are configured to grab and collect debris from a drain pipe.

2. The drain cleaning device according to claim 1, wherein the rotary motion input device for rotating the elongated shaft is selected from the group consisting of: (i) a drill, (ii) a screwdriver, (iii) a power drill, (iv) a power screwdriver, and (v) a detachable handle section.

3. The drain cleaning device according to claim 1, wherein the elongated shaft further comprises a hook material strip bonded to the second end thereof, the hook material strip comprising the plurality of protruding elements of the elongated shaft, and the hook material strip being made from a hook side of a hook-and-loop fastener material.

4. The drain cleaning device according to claim 3, wherein the elongated shaft is formed from a semi-flexible cable, the semi-flexible cable comprising a plurality of bundled wires, the hook material strip being bonded to an outer surface of the semi-flexible cable.

5. The drain cleaning device according to claim 1, wherein the elongated shaft comprises a plastic shaft.

6. The drain cleaning device according to claim 1, further comprising a power tool adapter configured to couple the first end of the elongated shaft section to the rotary motion input device, the power tool adapter includes an adapter body with a shank section for being inserted into a recess of the rotary motion input device.

7. The drain cleaning device according to claim 1, wherein the rotary motion input device is in a form of a detachable handle section configured to be detachably coupled to the elongated shaft of the drain cleaning device.

8. The drain cleaning device according to claim 7, wherein the detachable handle section has a proximal end portion and a distal end portion, the distal end portion of the detachable handle section being configured to be detachably coupled to a proximal end portion of the elongated shaft of the drain cleaning device.

9. The drain cleaning device according to claim 8, further comprising a sleeve member that is slidable along a length of the detachable handle section between (i) a disengaged position where the elongated shaft of the drain cleaning device is able to be released from the detachable handle section, and (ii) an engaged position where the distal end portion of the detachable handle section is locked into engagement with the proximal end portion of the elongated shaft of the drain cleaning device.

10. The drain cleaning device according to claim 9, wherein, in the engaged position of the sleeve member, the sleeve member is rotatably disposed about the detachable handle section, the sleeve member configured to be grasped by a hand of a user during the spinning of the drain cleaning device by the user so as to help stabilize the drain cleaning device, the drain cleaning device being configured to be rotated relative to the sleeve member while the sleeve member is held stationary by the hand of the user.

11. The drain cleaning device according to claim 8, wherein the detachable handle section comprises a pushbutton release assembly configured to releasably engage the proximal end portion of the elongated shaft of the drain cleaning device so as to releasably secure the detachable handle section to the elongated shaft.

12. The drain cleaning device according to claim 1, wherein the elongated shaft further comprises a plurality of longitudinal sections that are configured to connect together using one or more extension couplers.

13. The drain cleaning device according to claim 12, wherein at least one of the one or more extension couplers comprises an extension coupler female portion that is configured to engage with a corresponding extension coupler male portion.

14. The drain cleaning device according to claim 13, wherein the extension coupler female portion comprises a plurality of internal threads that are configured to threadingly engage with a corresponding plurality of external threads on the extension coupler male portion.

15. The drain cleaning device according to claim 12, wherein at least one of the plurality of longitudinal sections comprises a tip longitudinal section that includes the plurality of protruding elements, the tip longitudinal section configured to be discarded after being used to grab and collect the debris from the drain pipe.

16. The drain cleaning device according to claim 12, wherein at least some of the plurality of longitudinal sections comprise a plurality of different tip longitudinal sections that are able to be interchangeably attached to a distal end portion of the elongated shaft.

17. The drain cleaning device according to claim 16, wherein the plurality of different tip longitudinal sections comprises one or more of the following: (i) a tip longitudinal section including a hook material strip, (ii) a tip longitudinal section including a brush with bristles, and (iii) a tip longitudinal section including a spiral spring-shaped tip.
